(19) United States
(12) Patent Application Publication
(10) Pub. No.: US 2019/0065532 A1
(43) Pub. Date: Feb. 28, 2019

(54) SYSTEMS AND METHODS FOR IDENTIFYING SECURITY, SAFETY, AND WELLNESS CLIMATE CONCERNS FROM SOCIAL MEDIA CONTENT

(71) Applicant: Social Sentinel, Inc., Burlington, VT (US)

(72) Inventors: Natasha Conahan, San Diego, CA (US); Andrew J. Reischer, Ridgefield, CT (US); Gary J. Margolis, Richmond, VT (US)

(21) Appl. No.: 16/114,194

(22) Filed: Aug. 27, 2018

Related U.S. Application Data
(60) Provisional application No. 62/550,097, filed on Aug. 25, 2017.

(51) Int. Cl. G06F 17/30; G06Q 50/00

(52) U.S. Cl. CPC G06F 17/30283; G06Q 50/01; G06F 17/30876

(57) ABSTRACT

Exemplary embodiments provide methods and systems for identifying safety and security threat concerns and safety and wellness climate concerns from social media content. Social media content is searched based identify threatening content and safety and wellness climate concerns relevant to an enterprise, rather than benign user information. Identification of enterprise-relevant threatening content triggers generation and transmission of a threat alert to a device associated with the enterprise. Identification of enterprise-relevant safety and wellness climate concerns in social media content causes information regarding the results to be aggregated and analyzed, with the results of the analysis and aggregation presented to a user via a graphical user interface (e.g., to view results over time).

CROSS-REFERENCE TO RELATED PATENT APPLICATION

This application claims priority to U.S. Provisional Application 62/550,097 filed on Aug. 25, 2017, the content of which is hereby incorporated by reference in its entirety.

### BACKGROUND

Social media has become a widely accepted venue for communication in our society. Social media and social network applications have become popular for sharing content—such as image content, video content, audio content, textual content, and location content—through the Internet. A user of a social network application can create and share content via a social network application using, for example, posts, messages, comments, blogs, and mobile device settings. Users share their life stories, their triumphs, their woes and failures; they document their everyday life. Additionally, users also may share real actionable safety and security threats (e.g., harm to selves, harm to others). Social media content can be assessed to identify safety and security threats.

However, the public in general and, more specifically, social media application providers, do not want the “life story” of social media users, which is made public via social media content by the users themselves, used against them. Thus, there is a need to identify threats while ignoring the benign life story of a user. Some conventional systems and services allow an operator interested in detecting safety and security threats to monitor any social media content of a user, which is fraught with the potential to misuse a social media user's life story and is dependent on the operator of the monitoring system to ignore the benign life story of the social media user. This can be unacceptable to both the general public and the social media application providers.

For enterprises, such as educational institutions, information regarding topics linked to the campus safety culture, school safety climate, safety-related sentiment, and safety-related social or emotional learning environment is important for evaluating the progress and success of the educational institution, and for certain institutions such as private schools and higher education, can impact the bottom line of the school. Such information is ordinarily obtained via methods such as surveys; however, such methods only capture information at a few distinct points in time (e.g., when the survey is conducted) and suffer from the drawbacks generally associated with surveys (e.g., difficulty getting responses, responses may not be honest or accurate, bias in who decides to respond to the survey, etc.).

### SUMMARY

An example embodiment provides a method for identifying from social media content information related to the safety- or security-related culture, climate, sentiment, or social/emotional learning environment of an enterprise (referred to herein as “safety and wellness climate”), for identifying safety and security threat concerns, and for collecting, analyzing and viewing aggregate information regarding safety and wellness climate concerns from social media content.

In some embodiments, a method for identifying safety and wellness climate concerns from social media content includes storing a library of terms in a database, the library of terms including terms to constrain searching of social media content to safety and wellness climate concerns. The method includes obtaining or accessing an identification of an enterprise. The method also includes identifying social media content that includes safety and wellness climate concerns. The identification of social media content including safety and wellness climate concerns can be based on one or more of the following detection of one or more terms from the library of terms associated with safety concerns in the social media content in response to an execution of a search, detection of one or more terms from the library of terms and one or more attributes in the social media content in response to an execution of a search, or detection of a combination of one or more enterprise-related search terms and one or more terms from the library of terms in the social media content in response to an execution of a search. Where identifying social media content that includes safety and wellness climate concerns is based on detection of one or more terms from the library of terms associated with safety concerns in the social media content in response to an execution of a search, the method further includes identifying enterprise-relevant social media content that includes safety and wellness climate concerns by determining an existence of a relationship between the enterprise and the identified social media content that includes safety and wellness climate concerns. Where identifying social media content that includes safety and wellness climate concerns is based on detection of one or more terms from the library of terms and one or more attributes in the social media content in response to an execution of a search, or detection of a combination of one or more enterprise-related search terms and one or more terms from the library of terms in the social media content in response to an execution of a search, the identified social media content is enterprise-relevant social media content that includes safety and wellness climate concerns. The method further includes aggregating and analyzing information regarding the identified enterprise-relevant social media content that includes safety and wellness climate concerns.

In some embodiments, the one or more attributes establish a relationship between the social media content and the enterprise.

In some embodiments, the one or more attributes include one or more of: a geo-location associated with the social media content, information regarding an author of the social media content, or metadata of the social media content.

In some embodiments, information identifying an author of the social media content is removed or redacted from the information regarding the identified enterprise-relevant social media content that includes safety and wellness climate concerns prior to aggregation and analysis of the information regarding the identified enterprise-relevant social media content that includes safety and wellness climate concerns.

In some embodiments, the method further including displaying results of the aggregation and analysis of information regarding the identified enterprise-relevant social media content that includes safety and wellness climate concerns via a graphical user interface. The information identifying the author of the social media content is removed or redacted from the information regarding the identified enterprise-relevant social media content that includes safety and wellness climate concerns prior to displaying results of the aggregation and analysis via a graphical user interface.

In some embodiments, the method further including automatically executing by the processor, searches for one or more terms from the library of terms in social media content at periodic time intervals.

In some embodiments, the one or more enterprise-related search terms include one or more search terms provided by the enterprise.

In some embodiments, the one or more search terms are stored in a database.

In some embodiments, terms in the library are organized into topics and each topic includes an algorithm used to combine the one or more enterprise-related search terms with the one or more terms from the library under the respective topic, wherein an algorithm for one or more of the topics is different for an algorithm for another of the topics.

In some embodiments, the existence of the relationship between the social media content that includes safety and wellness climate concerns and the enterprise is determined by the social media content or the one or more attributes.

In some embodiments, the one or more enterprise-related search terms relate to or describe the enterprise. In some embodiments, the one or more enterprise-related search terms include one or more search terms provided by the enterprise.

In some embodiments, information regarding the identified enterprise-relevant social media content that includes safety and wellness climate concerns is analyzed to detect a trend and a trend alert is issued based on the analysis.

In some embodiments, the method further includes generating and transmitting the trend alert to the enterprise.

In some embodiments, a method for identifying security, safety, and wellness climate concerns from social media content includes storing a threating content library of terms in a database, the threatening content library of terms including terms to constrain searching of social media content to threating content. The method also includes storing a safety and wellness content library of terms in a database, the safety and wellness content library of terms including terms to constrain searching of social media content to safety and wellness climate concerns. The method also includes obtaining or accessing an identification of an enterprise. The method further includes identifying social media content that includes threating content or safety and wellness climate concerns. Social media content that includes threating content or safety and wellness climate concerns is identified based on one or more of the following: detection of one or more of terms from the threatening content library of terms in the social media content or detection of one or more terms from the safety and wellness library of terms associated with safety concerns, in response to an execution of a search; detection of one or more terms from the threatening content library of terms or the safety and wellness library of terms and one or more attributes in the social media content in response to an execution of a search; or detection of a combination of one or more enterprise-related search terms and one or more terms from the threatening content library of terms or the safety and wellness library of terms in the social media content in response to an execution of a search. Where identifying social media content that includes threatening content or safety and wellness climate concerns is based on detection of one or more of terms from the threatening content library of terms in the social media content or detection of one or more terms from the safety and wellness library of terms associated with safety concerns, the method further including identifying enterprise-relevant social media content that includes the threatening content or safety and wellness climate concerns by determining an existence of a relationship between the enterprise and the identified social media content that includes threatening content or safety and wellness climate concerns. Where identifying social media content that includes threatening content or safety and wellness climate concerns is based on detection of one or more terms from the threatening content library of terms or the safety and wellness library of terms_and one or more attributes in the social media content, or detection of a combination of one or more enterprise-related search terms and one or more terms from the threatening content library of terms or the safety and wellness library of terms in the social media content the identified social media content is enterprise-relevant social media content that includes threatening content or safety and wellness climate concerns. Where the identified enterprise-related social media content that includes threatening content or safety and wellness climate concerns includes safety and wellness climate concerns, the method further includes aggregating and analyzing information regarding the social media content in the enterprise-relevant social media content that includes safety and wellness climate concerns. Where the identified enterprise-related social media content that includes threatening content or safety and wellness climate concerns includes threating content, the method further includes transmitting an alert to a device associated with the enterprise regarding the threatening content.

In some embodiments, the one or more attributes establish a relationship between the social media content and the enterprise. In some embodiments, the one or more attributes includes one or more of: a geo-location associated with the social media content, information regarding an author of the social media content, or metadata of the social media content.

In some embodiments, information identifying an author of the social media content is removed or redacted from the information regarding the identified enterprise-relevant social media content that includes safety and wellness climate concerns prior to aggregation and analysis of the information regarding the identified enterprise-relevant social media content that includes safety and wellness climate concerns.

In some embodiments, the method further includes displaying results of the aggregation and analysis of information regarding the identified enterprise-relevant social media content that includes safety and wellness climate concerns via a graphical user interface. The information identifying the author of the social media content is removed or redacted from the information regarding the identified enterprise-relevant social media content that includes safety and wellness climate concerns prior to displaying results of the aggregation and analysis via a graphical user interface.

In some embodiments, the method further includes automatically executing by the processor, searches for one or more terms from the safety and wellness content library of terms and/or from the threatening content library of terms in social media content at periodic time intervals.

In some embodiments, the one or more enterprise-related search terms include one or more search terms provided by the enterprise.

In some embodiments, the one or more enterprise-related search terms are stored in a database.

In some embodiments, terms in the threatening content library and/or the safety and wellness content library are organized into topics.

In some embodiments, a system for identifying safety and wellness climate concerns from social media content includes a processor and a memory in communication with the processor. The memory can store instructions that causes the processor to: store a library of terms in a database, the library of terms including terms to constrain searching of social media content to safety and wellness climate concerns, obtain or access an identification of an enterprise, and identify social media content that includes safety and wellness climate concerns. The social media content that includes safety and wellness climate concerns is identified based on one or more of the following: detection of one or more terms from the library of terms in the social media content associated with safety concerns in response to an execution of a search, detection of one or more terms from the library of terms and one or more attributes in the social media content in response to an execution of a search, or detection of a combination of one or more enterprise-related search terms and one or more terms from the library of terms in the social media content in response to an execution of a search. Where identification of social media content that includes safety and wellness climate concerns is based on detection of one or more terms from the library of terms in the social media content associated with safety concerns in response to an execution of a search, the processor identifies enterprise-relevant social media content that includes safety and wellness climate concerns by determining an existence of a relationship between the enterprise and the identified social media content that includes safety and wellness climate concerns. Where identification of social media content that includes safety and wellness climate concerns is based on detection of one or more terms from the library of terms and one or more attributes in the social media content in response to an execution of a search, or detection of a combination of one or more enterprise-related search terms and one or more terms from the library of terms in the social media content in response to an execution of a search, the identified social media content is enterprise-relevant social media content that includes safety and wellness climate concerns. The processor further aggregates and analyzes information regarding the identified enterprise-relevant social media content that includes safety and wellness climate concerns.

In some embodiments, a non-transitory computer-readable storage medium storing code representing instructions that when executed are configured to cause a processor to store a library of terms in a database, the library of terms including terms to constrain searching of social media content to safety and wellness climate concerns, obtain or accessing an identification of an enterprise, and identify social media content that includes safety and wellness climate concerns. The social media content that includes safety and wellness climate concerns is identified based on one or more of the following: detection of one or more terms from the library of terms in the social media content associated with safety concerns in response to an execution of a search, detection of one or more terms from the library of terms and one or more attributes in the social media content in response to an execution of a search, or detection of a combination of one or more enterprise-related search terms and one or more terms from the library of terms in the social media content in response to an execution of a search. Where the processor identifies social media content that includes safety and wellness climate concerns based on detection of one or more terms from the library of terms in the social media content associated with safety concerns in response to an execution of a search, the processor identifies enterprise-relevant social media content that includes safety and wellness climate concerns by determining an existence of a relationship between the enterprise and the identified social media content that includes safety and wellness climate concerns. Where the processor identifies social media content that includes safety and wellness climate concerns based on detection of one or more terms from the library of terms and one or more attributes in the social media content in response to an execution of a search, or detection of a combination of one or more enterprise-related search terms and one or more terms from the library of terms in the social media content in response to an execution of a search, the identified social media content is enterprise-relevant social media content that includes safety and wellness climate concerns. The processor further aggregates and analyzes information regarding the identified enterprise-relevant social media content that includes safety and wellness climate concerns.

### BRIEF DESCRIPTION OF DRAWINGS

Some embodiments are illustrated by way of example in the accompanying drawings and should not be considered as a limitation of the invention:

FIG. 1 is a block diagram showing a system implemented in modules, according to an example embodiment;

FIG. 2 is a flowchart showing an example method for identifying safety, security, and wellness climate concerns related to an enterprise from social network content, according to an example embodiment;

FIG. 3 is a flowchart showing an example method for identifying safety, security, and wellness climate concerns from social media content, according to an example embodiment;

FIG. 4 is a flowchart showing an example method 400 for identifying relationships from social network content to mitigate enterprise safety and security concerns, according to an example embodiment;

FIG. 5 is a flowchart showing an example method for identifying safety and wellness climate concerns from social media content, according to an example embodiment;

FIG. 6 is a flowchart showing an example method for identifying safety, security, and wellness climate concerns from social media content, according to an example embodiment;

FIG. 7 illustrates a network diagram depicting a system for implementing embodiments of a safety, security, and wellness climate concerns system; and

FIG. 8 is a block diagram of an example computing device that may be used to implement exemplary embodiments of systems described herein.

FIGS. 9-14 are graphical depictions of graphical user interfaces for displaying aggregated safety and wellness climate concerns information over time and results of analysis.

### DESCRIPTION OF EXEMPLARY EMBODIMENTS

The inventors recognized a need for safety and security threat detection in public social media content in a manner that honors users' privacy and is consistent with social network application providers' policies and concerns. The inventors also recognized a need for efficient systems and methods to aggregate and analyze social media content regarding safety and wellness climate concern relevant to a particular enterprise (e.g., school or organization). Described herein are systems, methods, and non-transitory computer readable medium for identifying safety, security, and wellness climate concerns from social media content, for issuing alerts based on threatening content, and for aggregating, analyzing and displaying information from social media content regarding a safety and wellness climate within or associated with an enterprise, without exposing the benign life story of authors of the social media content. Embodiments of the present invention enable constrained searching of social media content to identify content that includes safety and security threat concerns, which is also referred to herein as threatening content, and to identify, aggregate and analyze content regarding safety and wellness climate concerns, rather than a social media author's benign life story or comments. Embodiments include the use of a library of terms to constrain searching of social media content to threatening content and to social media content regarding a safety and wellness climate concern or issue within or associated with an enterprise.

Some embodiments include a threatening content library of terms including terms to constrain searching of social media content to threatening content. Some embodiments include a safety and wellness library of terms including terms to constrain searching of social media content to safety and wellness concerns. In some embodiments, the safety and wellness library of terms can include terms that are associated with safety- and wellness-related sentiment. Additionally, the safety and wellness library of terms can include terms that are associated with safety concerns.

Some embodiments opportunistically pattern match content in social media posts against a library of terms (i.e., a threatening content library of terms and/or safety and wellness library of terms) to identify safety and security threats and safety and wellness climate concerns, to send alerts regarding threatening content, and to aggregate and analyze information regarding content with safety and wellness climate concerns, while ignoring the benign life story contained in social media posts, which is desirable from the point of view of the authors of social media posts and from the point of view of the social media application providers.

In some embodiments, the results of the threatening content searches and the safety and wellness climate concern searches are treated differently. For example, the results of the threatening content searches may be associated with safety and security threats or with imminent safety and security threats. Threat alerts may be issued based on the results of the threatening content searches. A threat alert may be sent based on a social media post that is deemed to have information indicating a significant or imminent safety or security concern. The threat alert may include information that is needed or helpful to address the significant or imminent threat (e.g., some or all of the content of the post, information identifying the author of the post if provided in the post, a link to view the post in its original context, etc.). In contrast, the results of the safety and wellness climate concerns searches are used to analyze aggregate information over time and do not include information identifying the author of the post.

In all embodiments, results of safety and wellness climate concerns searches are stripped of personally identifying information (PII) regarding the author of the content prior to displaying any information to an enterprise user of the system to protect the privacy of the author of the social media content that is returned by the safety and wellness climate concerns searches. Additionally, information regarding numbers of items (e.g., posts) and topics or subtopics into which the items fall may be kept for longer periods of time to allow an enterprise user to view trends over various time periods of interest (e.g., historical trends). In some embodiments, the system can save or store selected information associated with the content from the individual items (e.g., posts), but not the post itself. In all embodiments, the system protects the privacy of the author prior to displaying or making accessible any information regarding or results of aggregation and analysis by removing any personally identifying information associated with the author based on detection of the personally identifying information. In some embodiments, the type of information stored regarding individual items (e.g., posts) or from individual items is based on one or more agreements with one or providers of the social media content. In some embodiments, both the type of information stored regarding individual items or from individual items and the duration of storage is based on one or more agreements with one or more providers of the social media content. In some embodiments, results of the threatening content searches may be included with the results of the safety and wellness climate concerns searches for additional analysis and display of aggregate information. In some embodiments, selected information regarding individual items resulting from the safety and wellness climate concern searches can be extracted from the social media web domains for temporary or longer periods of storage.

In some embodiments, analysis of information regarding the safety and wellness climate concerns social media content, which may be referred to herein as the safety and wellness climate concerns data, is used to detect trends. In some embodiments, analysis of the safety and wellness climate concerns data can be used to generate a trend alert, indicating increased social media activity in a topic or concerning particular subject matter or a particular issue. In some embodiments information regarding the trend, such as a topic and commonly used keywords, may be sent to the enterprise as part of the alert. In some embodiments, a trend alert may contain different, more, or less, data surrounding the issue or the social media content addressing the issue than the data that would be included in a threat alert. For example, in all embodiments, no personally identifiable information regarding the author or authors of the social media content that triggered the trend alert is included in the trend alert sent to a user.

Conventionally searching social media content places too much burden, in both time and decision making, on enterprises. Moreover, unconstrained searching of content available via social network applications may produce a user's benign life story and comments in the search results, which may need to be filtered. The systems and methods described herein provide for constrained searching of content on social media applications. The systems and methods are configured to detect social media content that may be relevant to threat concerns, as well as safety and wellness concerns, while filtering out content associated with a user's benign life story. In this regard, the described systems and methods provide for a technical solution of reducing the need of computational resources and increased operational efficiency by reducing the amount of data collected and processed. Furthermore, the claimed system can quickly and effectively detect and identify threats and safety and wellness concerns on social media network applications by interfacing with the social media network applications and reviewing and analyzing the content available on the social media network application.

When developing a threat alert system for safety and security concerns, the inventors developed various methods to distinguish content that indicated a significant or imminent threat, which was used for generation of safety and security threat alerts, from content that included information relevant to safety and security, but that did not indicate a significant or imminent threat, which was not used for generation of safety and security threat alerts. Through the process of developing the threat alert system, the inventors realized that the content relevant to safety and security, but which does not rise to the level of warranting a threat alert, would still be of interest to some users as it can provide information regarding a safety and wellness climate within or associated with an enterprise.

Described herein is a method and system to analyze and display information regarding content relevant to a safety and wellness climate within or associated with an enterprise, without exposing personally identifying information regarding the social media author, unless the content independently is identified by the system as constituting a safety and security threat alert (e.g., threatening content). Some systems and methods disclosed herein obtain needed information regarding threatening content and track of safety and wellness climate concerns over time without exposing the benign life story of a social media author.

Some embodiments described herein provide a threat alert and/or safety and wellness climate system that identifies threatening content from social media content and/or obtains and analyzes information regarding safety and wellness climate concerns, while ignoring an author's benign life story. Embodiments provide a library of terms (i.e., threatening content library of terms and/or safety wellness library of terms), which can be stored in a database, that relate to threatening content and/or that relate to safety and wellness climate concerns. In some embodiments, the library terms (i.e., threatening content library of terms and/or safety wellness library of terms) also include terms that relate to benign life story, so those terms can be used to exclude social media content results that include benign life story.

Some embodiments include a threatening content library of terms including terms to constrain searching of social media content to threatening content. Additionally, some embodiments can include a safety and wellness library of terms including terms to constrain searching of social media content to safety and wellness concerns. In some embodiments, the safety and wellness library of terms can include terms that are associated with safety- and wellness-related sentiment. Additionally, the safety and wellness library of terms can include terms that are associated with safety concerns.

The described system can identify social media content including safety and wellness climate concerns based on searching for and detecting one or more library terms associated with safety concerns from the safety and wellness library of terms in the social media content. Alternatively or additionally, the described system can identify social media content including safety and wellness climate concerns based on searching for and detecting one or more library terms from the safety and wellness library of terms in the social media content along with attributes included in the social media content. The attributes can include, but are not limited to, geo-location associated with the social media content, the author of the social media content, and/or the metadata of the social media data. Alternatively or additionally, the system can receive enterprise-related search terms from an enterprise. The system can generate a combination of one or more enterprise-related search terms and one or more terms from the safety and wellness library of terms. The system can search for and detect social media content including safety and wellness climate concerns, based on the combination of the one or more search terms and the one or more library of terms. The system constrains the search of social media content to identify information related to safety and wellness climate concerns without identifying benign content regarding a user's life story. The system can execute each of the searches automatically after periodic time intervals.

The described system can identify social media content including threating content based on searching for and detecting one or more library terms from the threatening content library of terms in the social media content. Alternatively or in addition to, the described system can identify social media content including threating content based on searching for and detecting one or more library terms from the threatening content library of terms in the social media content along with attributes included in the social media content. The attributes can include geo-location associated with the social media content, the author of the social media content, and/or the metadata of the social media data. Alternatively, or in addition to, the system can receive search terms from an enterprise. The system can generate a combination of one or more enterprise-related search terms and one or more terms from the threatening content library of terms. The system can search for and detect social media content including threating content based on the combination of the one or more enterprise-related search terms and the one or more terms from the threatening content library of terms. The system constrains the search of social media content to identify threatening content and information related to safety and wellness climate concerns without identifying benign content regarding a user's life story. The system can execute each of the searches automatically after periodic time intervals.

It can be appreciated the system can search and detect social media content including safety and wellness climate concerns and threating content separately. Alternatively or additionally the system can search and detect social media content including safety and wellness climate concerns and threating content concurrently.

The system described herein limits unconstrained searches. Unconstrained searches are fraught with misuse, target benign life stories of users, can overwhelm the operator of an assessment system with a sea of false positives, and consume vast amounts of data. Unconstrained searches can increase the need of computational resources and decrease operational efficiency. In some embodiments, the system described employs libraries of terms (i.e., threatening content library of terms and/or safety wellness library of terms) to identify results that include potential safety and/or security threats (e.g., include threatening content) relevant to an enterprise or are related to a safety and wellness climate of an enterprise, while reducing or minimizing results that are not related to threatening content or safety and wellness climate concerns. As used herein, constrained searching refers to incorporating one or more terms from the library (i.e., threatening content library of terms and/or safety wellness library of terms) so that search results identified from searching social media content do not relate to an author's benign life story. Constrained searches can reduce the need of computational resources and increase operational efficiency.

Some systems and methods incorporate both detection of threatening content regarding an enterprise and aggregation, analysis and display of information regarding safety and wellness climate concerns within the enterprise. Information regarding safety and wellness climate concerns within the enterprise can include safety and security information that does not rise to the level of a threat that would warrant an alert (e.g., the threat is not imminent, the threatened behavior would not be significant) and information related to safety and wellness climate concerns. For example, the library of terms (i.e., threatening content library of terms and/or safety wellness library of terms) used to constrain searches may include both terms related to threatening content and additional terms that are not related to threatening content, but that are related to a safety or wellness climate within the enterprise (e.g., “I love Professor X”, “I hate school”). In some embodiments, one or more terms that are related to threatening content may also be related to safety or wellness climate concerns, but the particular search algorithm applied for a search for threatening content is different from the search algorithm applied for information regarding safety and wellness climate concerns. For example, a limit on the proximity of a term such as “gun” to a behavioral phrase, such as “shoot up the school,” would be different for a threatening content search than for a safety and wellness climate concerns search, where having the term gun closer to the behavioral phrase “safety rules” would more likely indicate information regarding safety and wellness climate concerns, as opposed to an imminent safety and security threat. In some embodiments, a combination of one or more terms from the library (i.e., threatening content library of terms and/or safety wellness library of terms) and an algorithm that specifies how to combine the one or more terms from the library (i.e., threatening content library of terms and/or safety wellness library of terms) is described as a template. In some embodiments, the combination also includes how to combine one or more enterprise-relevant search terms with the library terms and an algorithm used to combine them. Many different templates would be employed for threatening content searches and many different templates would be employed for safety and wellness climate concerns searches. Although some of the library terms (i.e., threatening content library of terms and/or safety wellness library of terms) regarding threatening content may also appear in templates for safety and wellness climate concerns searches, in such cases the templates for the threatening content searches including those terms will be different than the templates for the safety and wellness climate concerns searches including those terms as the algorithms will be different.

The results from the threatening content searches are used for issuing alerts regarding individual items (e.g., individual posts) that indicate a safety or security threat (e.g., an imminent safety or security threat). The results of the safety and wellness climate concerns searches are aggregated and analyzed to provide information regarding safety and wellness climate concerns within or associated with an enterprise over time. The analysis of the results may be used to detect a trend and issue an alert based on the trend, which may be detected as a number of posts over a threshold number for a category (e.g., a topic or a rule) within an amount of time, or a percentage or proportional increase or decrease in posting numbers for a category (e.g., a topic or a rule) within a certain amount of time. As noted above, in some embodiments, results of the threatening content searches may be aggregated with the results of the safety and wellness climate concerns searches for analysis of trends over time, however, prior to or when such aggregation occurs, any and all personally identifying information would be removed or redacted from information regarding results of the threatening content searches.

In some embodiments, the features for collecting, analyzing and viewing aggregate information regarding safety and wellness climate concerns, which may include information regarding a safety or wellness culture associated with an enterprise, may help enterprises better understand how safety, security and risk issues are being discussed at the aggregate level relative to the enterprise and the enterprise's assets. With this insight, the enterprise is able to put in place safety and education programs and initiatives and/or evaluate how the enterprise is performing. The enterprise is better able to spot areas of weakness that need to be addressed holistically so that it can better ensure the safety and success of its communities and brands.

One example is kindergarten through twelfth grade educational enterprises. School districts are charged with maintaining a positive and safe school climate. Studies show that there is a significant difference in student achievement between schools with a good school climate and those with a poor school climate. A school climate is considered good when students report feeling safe and connected to a caring adult and to other students. Conversely, students who express a lack of physical safety, a lack of access to healthy relationships, and/or acknowledge repeatedly experiencing bullying or suffering from other mental health challenges make up communities with poor performing climate studies. School climate is a nationally recognized issue with very specific definitions and assessment and reporting structures. To date, the predominant way for a district to assess school climate and map it to their SEL (Social and Emotional Learning) programs is through an annual survey. In some embodiments, having access to near real-time data and data mapped throughout the school year to help spot trends may revolutionize school districts' abilities to enact, evaluate, and maintain critical student climate programs, many of which are tied to funding and mandated by state and Federal programs.

Another example involves higher education enterprises. Programs and efforts that promote inclusion and multicultural competency (and therefore combat racism, sexism and bigotry) are of critical importance on university and college campuses. Aside from reactively tracking related complaints made to the administration, campus officials are challenged to accurately assess the extent of the problem on their campuses in order to develop educational responses and solutions and then track the effectiveness of those solutions. Without visibility into the digital conversation—happening in-the-moment—some college officials express frustration at being the last to know when an issue that could have been resolved peacefully in the early phases, spirals out of control when fueled by the rapid spread of misinformation on social media. In many instances, beyond impacting the learning culture of the campus community, institutions of higher education are being held responsible by the US Department of Education Clery Act and Title IX compliance branches for campus issues related to multicultural competency. Government fines and negative press for campus issues related to multicultural competency can have a significant impact on the institution's brand identity. Further, administrators, students, and staff need to understand if programs being tested on campus to address multicultural competency issues are having an impact. The same can be said for issues associated with sexual and gender violence, sex trafficking, and important wellness indicators such as anger, fear, anxiety, and expressions of suicide and self-harm. By tapping into the publicly available digital discourse at an aggregate level, using systems and methods disclosed herein, campus officials will be able to spot areas in need of improvement and propose and evaluate methods to address areas of concern. For instance, identifying, confirming and better understanding certain periods during the year when anxiety and suicidal ideations pique may help with the development of proactive support and outreach programming.

Another example involves public safety. During storms and other extreme weather events, people are increasingly turning to social media to share and report downed powerlines, inaccessible roads, and community property destruction, as opposed to contacting the relevant authority or public utility company directly by telephone. Public safety teams rely on the community to help determine how to deploy resources after events, and the public safety teams' ability to provide life-saving support to the community is being impacted by their ability to access information in a timely manner. The trending alert feature could aid in providing early notice of issues like downed powerlines, inaccessible roads, and community property destruction based on social media content including safety and wellness climate concerns.

Another example involves company security. While companies are familiar with utilizing social media monitoring services to spot unfavorable commentary about their brand or a particular product, crowd-sourced information can be employed to look for safety, security, and risk issues for the companies, which could be identified using the safety and wellness climate concerns searches. This includes spotting trends associated with customer comfort at physical locations (e.g., a large number of people simultaneously expressing an issue with heat in an arena which can foreshadow a safety risk) or identifying potential safety concerns associated with their buildings or that impact employees.

Some embodiments enable users to identify trends at a macro level though charts and graphs to answer questions such as “Do we have more or fewer conversations related to students threatening students this month versus the month prior to the anti-violence presentation?” or “Do we have more or fewer self-harm or suicide related conversations this month versus last or this month last year?” or “Is there more conversation around narcotics use in our district versus other urban districts who have implemented more aggressive education campaigns?” The embodiments provide that individual posts that contribute to the aggregate safety and wellness climate concerns data cannot be viewed by the enterprise as the emphasis of the graphical user interface is on aggregate reporting and analytics rather than on individual posts. Further, the embodiments provide that posts and other information resulting from the safety and wellness climate concerns searches will have all personally identifying information regarding the author of the social media content removed, deleted or redacted so that it cannot be viewed or accessed by a user of the system.

In some embodiments, aggregated information and analysis regarding safety and wellness climate concerns is displayed in a graphical user interface of a computing device. The information may be displayed via charts, plots, graphs or other graphical methods of displaying data. In some embodiments, the graphical user interface is provided by an application hosted by a server and provided to the user via a website. In some embodiments, the graphical user interface is provided via an application installed on the enterprise user's device (e.g., the users' computer, the user's mobile device). In some embodiments, what particular information is displayed and the format of the display may be determined, at least in part, on input received from the user via the graphical user interface.

As used herein the phrase “search term” refers to enterprise-related information, which may be provided by the enterprise and may include multiple terms, multiple phrases and/or a listing of terms and phrases.

As a non-limiting example of the threatening content search and threat alert aspect of the system, the enterprise-related information may include a term that is a name of an asset of the enterprise, such as an important person working for the enterprise, like “Tom Brady.” In some embodiments, in the threatening content search, the system described herein combines the enterprise-related search term, for example “Tom Brady,” with a list of threatening terms stored in the library (i.e., threatening content library of terms and/or safety wellness library of terms) such as “kill,” “shoot,” or “bomb.” The system ignores the social media content consisting of posts like “Tom Brady is a great athlete,” or “Tom Brady is a bozo,” but identifies threatening social media content consisting of posts such as “I am going to kill Tom Brady.”

The system provides a library of terms (i.e., threatening content library of terms and/or safety wellness library of terms), which may include words, phrases, and algorithms to associate the library terms (i.e., threatening content library of terms and/or safety wellness library of terms) to social media content to identify safety and security threat concerns, which is described as threatening content. In embodiments that also include collection, aggregation and analysis of information regarding safety and wellness climate concerns within an enterprise, the library (i.e., threatening content library of terms and/or safety wellness library of terms) can also include terms that are not related to security threat concerns, but are relevant to the safety and wellness climate within the enterprise. The system also includes algorithms for associating the terms to social media content. The system may employ templates, where a template is a combination of one or more terms from the library (i.e., threatening content library of terms and/or safety wellness library of terms) and an algorithm used to associate the terms to social media content. In some embodiment where enterprise-related terms are employed, some templates include a combination of one or more terms from the library, one or more enterprise-related terms and an algorithm to associate the enterprise-related terms and the terms from the library for searching within social media content. Different templates would be used for searching for threatening content for issuing threat alerts than templates used for obtaining information regarding safety and wellness climate concerns to be aggregated and analyzed.

In some embodiments, the system enables an enterprise to provide information related to assets of interest or definition of protected assets, where assets may be a location, a building, a person, an event or an organization. In some embodiments, the system also enables an enterprise to define search terms such as keywords, phrases or hashtags, to search social media content in a constrained fashion as described herein.

As used herein, “enterprise” can refer to an organization, an entity, a business, an operation, an establishment, and the like. The term “enterprise” as used herein may also refer to a person or persons associated with an enterprise.

As used herein, “social network application” can refer to a social networking service, a social networking platform, a social networking website, a social media application, a social media service, a social media platform, a social media website (or web domain) and the like.

As used herein, “content” or “social media content” can refer to any user-generated content or user-published content on a social network or media application, or any content made available on a social network or media application via text, audio, or video media. A social network or media application may refer to content as posts, blogs, comments, status updates, notifications, check-ins, Tweets™, likes, reviews, and others. Sometimes the content may be associated with a hashtag. A user that generates or publishes social media content may be referred to as the “author” of the content that he or she generates. Some social media content may have more than one author. The content or social media content can be embodied as social media digital data. The social media digital data can include alphanumeric text, image data, video data, audio data, GIF data, and/or other types of data. In some embodiments, the author can be a bot or an automated script.

The following description is presented to enable any person skilled in the art to create and use a computer system configuration and related method and article of manufacture to identify safety, security, and wellness climate concerns from social media or network content. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

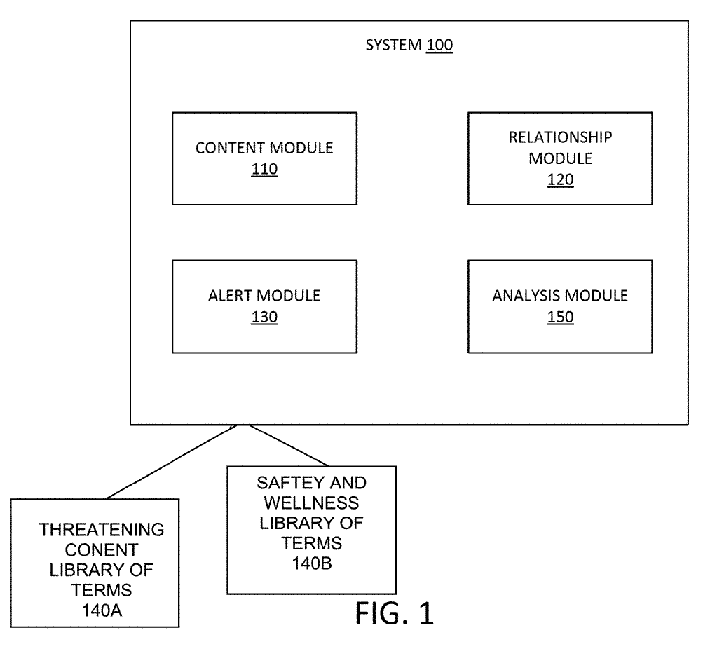

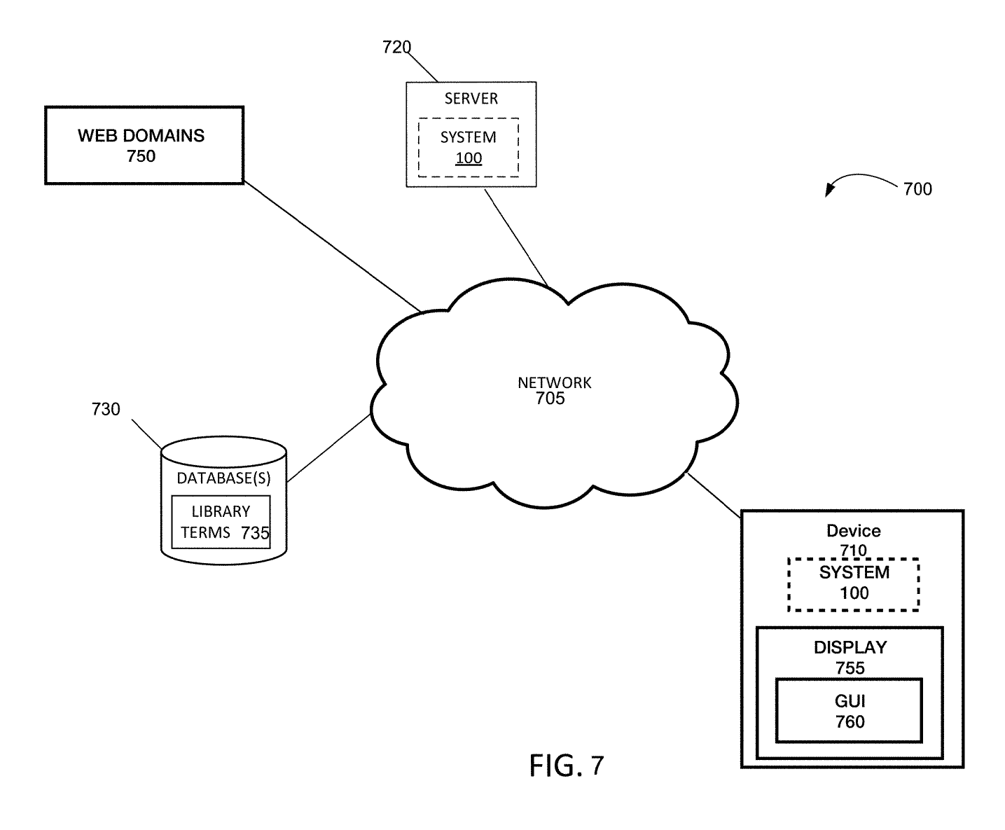

FIG. 1 is a block diagram showing example modules 110, 120, 130, 150 that can be included in a system 100, according to an example embodiment. The system 100 is in communication with a threatening content library of terms database 140a and a safety and wellness library of terms database 140b. In some embodiments, the threatening content library of terms database and the safety and wellness library of terms database may be a single database. The modules may be implemented using a device and/or a system, such as, but not limited to, device 710 or server 720 described below in relation to FIG. 7. The modules may include various circuits, circuitry and one or more software components, programs, applications, apps or other units of code base or instructions configured to be executed by one or more processors included in device 710 or server 720. In other embodiments, one or more of modules 110, 120, 130, 150 may be included in server 720, while others of the modules 110, 120, 130, 150 can be provided in device 710. Although modules 110, 120, 130, 150 are shown as distinct modules in FIG. 1, it should be understood that the procedures and/or computations performed using modules 110, 120, 130, 150 may be implemented using fewer or more modules than illustrated. It should be understood that any of modules 110, 120, 130, 150 may communicate with one or more components included in system 700, such as but not limited to database(s) 730, server 720, device 710, or social media web domains 750. In the example of FIG. 1, the system 100 includes a content module 110, a relationship module 120, and an alert module 130.

The content module 110 may be a hardware-implemented module that may be configured to search, and review content available on social network applications, and retrieve content of interest in some embodiments. The content module 110 may be configured to perform constrained searches of social media content to identify safety and security threats and/or information regarding safety and wellness climate concerns among an author's content while ignoring, overlooking or discounting the author's benign life story.

In one embodiment, the content module 110 can interface with social media web domains 750. The social media web domains 750 can be social media websites, can host, or can be embodied as social media network applications. The content module 110 can use Application Program Interfaces (APIs) to interface with the social media web domains 750.

The relationship module 120 may be a hardware-implemented module that may be configured to determine an existence of a relationship between a social media content author and/or the content identified by the content module 110 and an enterprise from the content available on social network applications. In some embodiments, the relationship module and store the existence of a relationship between an author of social media content and the enterprise in a database. In an example embodiment, the relationship module 120 can determine an existence of a relationship between the content identified by the content module 110 and an enterprise from the content identified by the content module 110.

In some embodiments, the relationship module 120 can identify a relationship between the content identified by the content module 110 and the enterprise, based on the detection of enterprise-related search terms in the content identified by the content module 110. In some embodiments, the enterprise-related search terms are employed along with the one or more terms from the library of terms for some searching.

Conventionally, determining and/or identifying whether content is relevant to an enterprise can be inefficient, error prone, and cumbersome. For example, conventional systems may require additional input from a user to confirm a relationship and/or extensive querying. However, in some embodiments, the described system can efficiently determine an existence of a relationship from the content available on the social network application. In this regard, the described system solves the technical solution of the need of computational resources and increases operational efficiency by reducing the number of queries or amount of input required to determine whether content is relevant to an enterprise.

The alert module 130, which may be a hardware-implemented module or a software-implemented module, is configured to generate and transmit a threat alert to the associated enterprise identifying content that includes safety and security threat concerns, which is also referred to as threatening content, so that the enterprise may address or mitigate the threat. The threat alert may be transmitted as an email message, a SMS message, or other communication means. In some embodiments, the alert may be incorporated into a report including multiple alerts for the enterprise. In some embodiments, the alert and/or the report may include the content of concern and information on the author of the content. As described above, the content is public content from social media provider and the information on the author of the content is public information from the social media provider. In some embodiments, the content includes proprietary information based on public social media content. In embodiments that also include detection of a trend based analysis of safety and wellness climate concerns results, the alert module 130 may also be employed to send out a trend alert.

The analysis module 150, which may be a hardware-implemented module or a software-implemented module, is configured to aggregate, analyze, and display information related to social media content identified as being relevant to safety and wellness climate concerns of an enterprise. The analysis module 150 stores information regarding each item of social media content identified as being relevant to the safety and wellness climate of an enterprise. In some embodiments, the stored information includes some or all of the following: topic(s) under which the item was identified, a subtopic under which the item was identified, and the library term or terms (i.e., threatening content library of terms and/or safety and wellness library of terms) used in the search that identified the item.

In some embodiment, the topics for safety and wellness climate can be embodied as indices. As a non-limiting example, the indices can include happiness index which can be derived from posts containing terms such as: laughter, happiness, love, happy, laughed, laugh, laughing, excellent, laughs, joy, successful, win, rainbow. As a non-limiting example the indices can include a fear index which can be derived with terms such as: terrorist, rape, terrorism, murder, death, cancer, killed, kill, died, torture, raped, deaths, arrested, killing, die, terror, jail, kills, war, murdered, killings, fatal, tortured, abused, sickness.

As a non-limiting example, in some embodiments, the stored information may include other important keywords appearing in the item, or a copy of the item (e.g., post). Any personally identifying information regarding the social network application user (e.g., the author of the social media content) will not be stored, or will be redacted or deleted from the stored information before the information is displayed to a user of the system. In some embodiments, what information is stored is determined in part, by an agreement with the social media provider of the content. In some embodiments, the system can save or store selected information associated with the content from the individual items (i.e., posts), but not the post itself. Alternatively or additionally, the system can protect the privacy of the user by removing/not storing/redacting/deleting any personally identifying information associated with the user, which may be determined based on detection of the personally identifying information, or based on an agreement with the social media providers.

In some embodiments, selected information regarding individual items (e.g., posts) resulting from a safety and wellness climate concerns search may be saved or stored for only short period of time (e.g., 2 days, 14 days, 30 days, or a period of time reached in agreement with social media providers) before being deleted, while information regarding numbers of items (e.g., posts) and topics or subtopics into which the items fall may be kept for longer periods of time to allow a user to view trends over various time periods of interest (e.g., historical trends).

In some embodiments, the system 100 can be provided proprietary social media data from a third party. The proprietary social media data can include social media data authored by various authors across multiple enterprises and geographic localities. The proprietary social media data can be data repositories aggregated by the third party. Alternatively, or additionally, the system can opt-in to a service (agreement) for the system 100 to download the proprietary data from a system associated with the third party. In some embodiments, the system 100 can download the proprietary data continually or periodically, e.g., at specified time intervals, in response to a message from the system associated with the enterprise, etc.

In some embodiments, the content module 110 may be configured to search and review content from the proprietary social media data. The relationship module 120 may be configured to determine an existence of a relationship between social media content author and/or the content identified by the content module 110 and an enterprise from the content available on proprietary social media data, and store the existence of a relationship in a database. It can be appreciated that any personally identifying information of the social media content author is not stored. In an example embodiment, the relationship module 120 can determine an existence of a relationship between the content identified by the content module 110 and an enterprise from the content identified by the content module 110.

In some embodiments, the analysis module 150 is configured to aggregate, analyze, and display information related to proprietary social media content identified as being relevant to safety and wellness climate concerns of the enterprise.

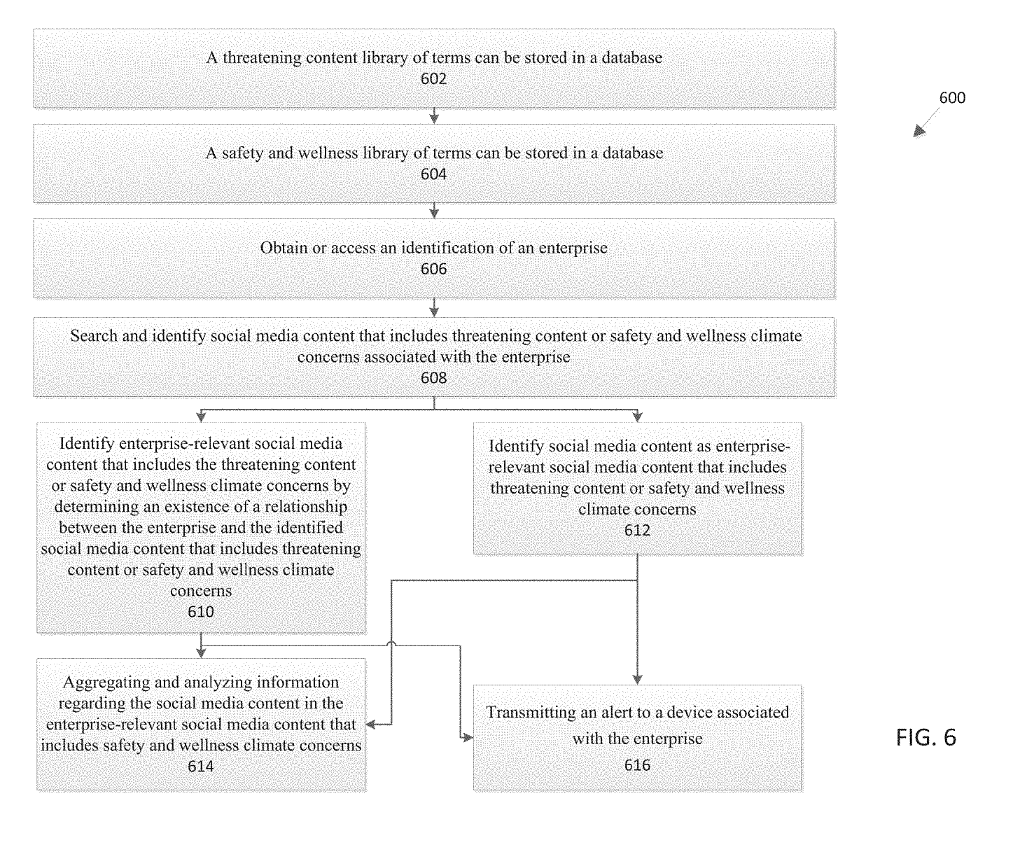

The analysis module 150 performs analysis, which may include generating graphs, charts, or plots of numbers of identified items, either cumulative or over a period of time, which may be sorted by topic, subtopic, library search term, keyword, etc. The results of the analysis may be displayed through a graphical user interface (GUI) 760. See, for example, FIGS. 6-11.

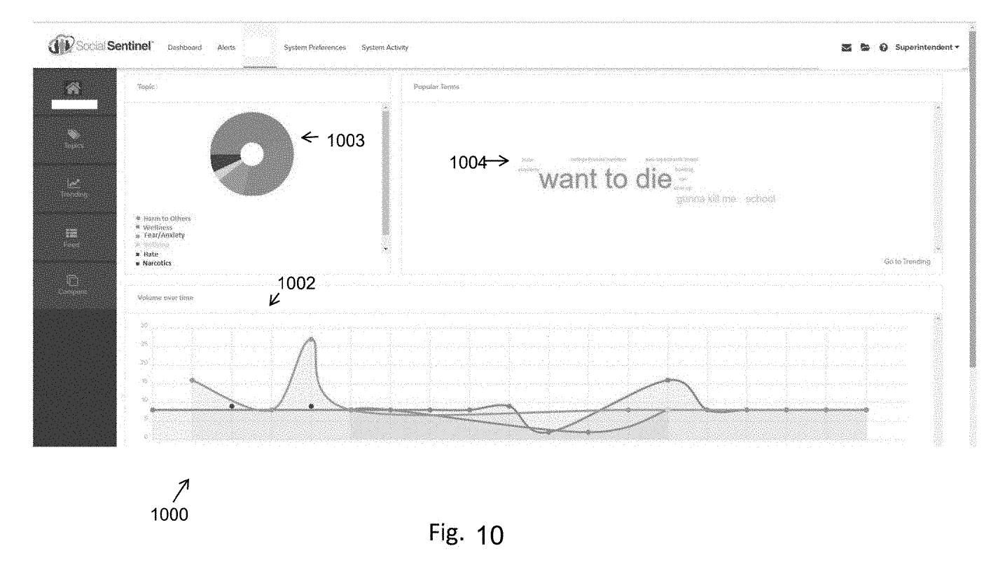

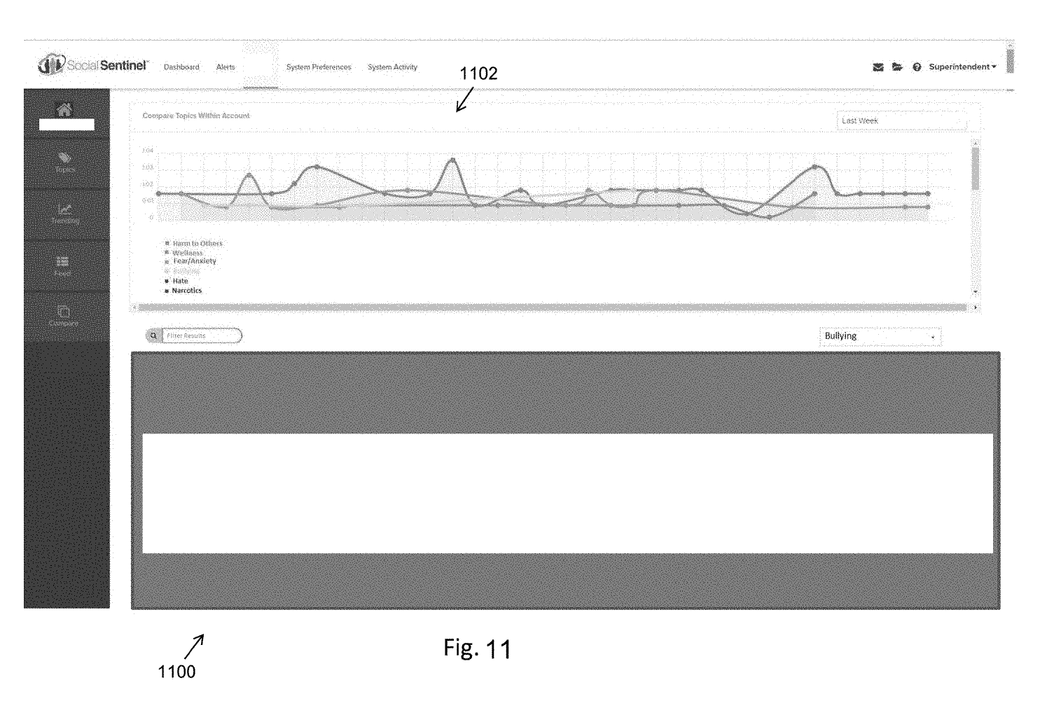

In some embodiments, the particular graphs, charts or plots may be generated based on a user selection through a graphical user interface. In some embodiments, the analysis module can generate graphs or other visual models/displays showing trends. See for example, FIGS. 10 and 11. In some embodiments, the analysis module performs analysis to detect a trend and generate an alert based on the trend. For example, a trend may be detected as a number of posts over a threshold number for a category (e.g., a topic or a rule) within an amount of time, or a percentage or proportional increase or decrease in posting numbers for a category (e.g., a topic or a rule) within a certain amount of time. The trend alert may include information such as some or all of: a topic or subtopic of the searches that yielded the items in the trend, library terms (i.e., threatening content library of terms and/or safety wellness library of terms) used in the searches that yielded the items that make up the trend, and keywords or phrases used by items in the trend. However, no personally identifying information for an author regarding items found using safety and wellness climate criteria search that appears in the trend will be included in the trend alert for some embodiments. As noted above, the trend alert may be generated or issued by the alert module 130.

In embodiments that store some safety and wellness climate criteria concerns data short term and store only a subset of the safety and wellness climate criteria concerns data long term, the analysis may be conducted on the short term stored data and on the long term stored data. In some embodiments, some types of analysis cannot be conducted on the long term stored data because it does not include the information required for analysis. For example, trend detection and trend alerts may be based on the short term stored data. A word cloud of popular terms may be based on short term data. An associated keyword analysis may be based on short term data.

The threatening content library of terms database 140a and a safety and wellness library of terms database 140b as described in detail below, may be configured to store a list of terms that includes phrases, referred to as the library terms (i.e., threatening content library of terms and/or safety wellness library of terms). In some embodiments, the terms in the threatening content library of terms database 140a and/or in a safety and wellness library of terms database 140b can be used to search social media content to detect threating content and/or safety and wellness climate concerns. In some embodiments, the terms in the threatening content library of terms database 140a and/or a safety and wellness library of terms database 140b along with certain attributes can be used for searching social media content to detect threating content and/or safety and wellness climate concerns. In some embodiments, one or more terms from the library terms (i.e., threatening content library of terms and/or safety wellness library of terms) are combined with the enterprise-related search terms by the content module 110 to perform constrained searches of social media content. In some embodiments, the library terms (i.e., threatening content library of terms and/or safety wellness library of terms) are organized by topic, and each topic may include or be associated with one or more algorithms for combining the library terms and/or phrases with the search terms to perform a constrained search of social media content. In some embodiments, a template refers to a combination of one or more library terms (i.e., threatening content library of terms and/or safety wellness library of terms) and an algorithm for combining the one or more library terms (i.e., threatening content library of terms and/or safety wellness library of terms) with the received search terms. In some embodiments, the templates are organized by topic as described below. Different templates are used for the threatening content searches than for the safety and wellness climate concerns searches.

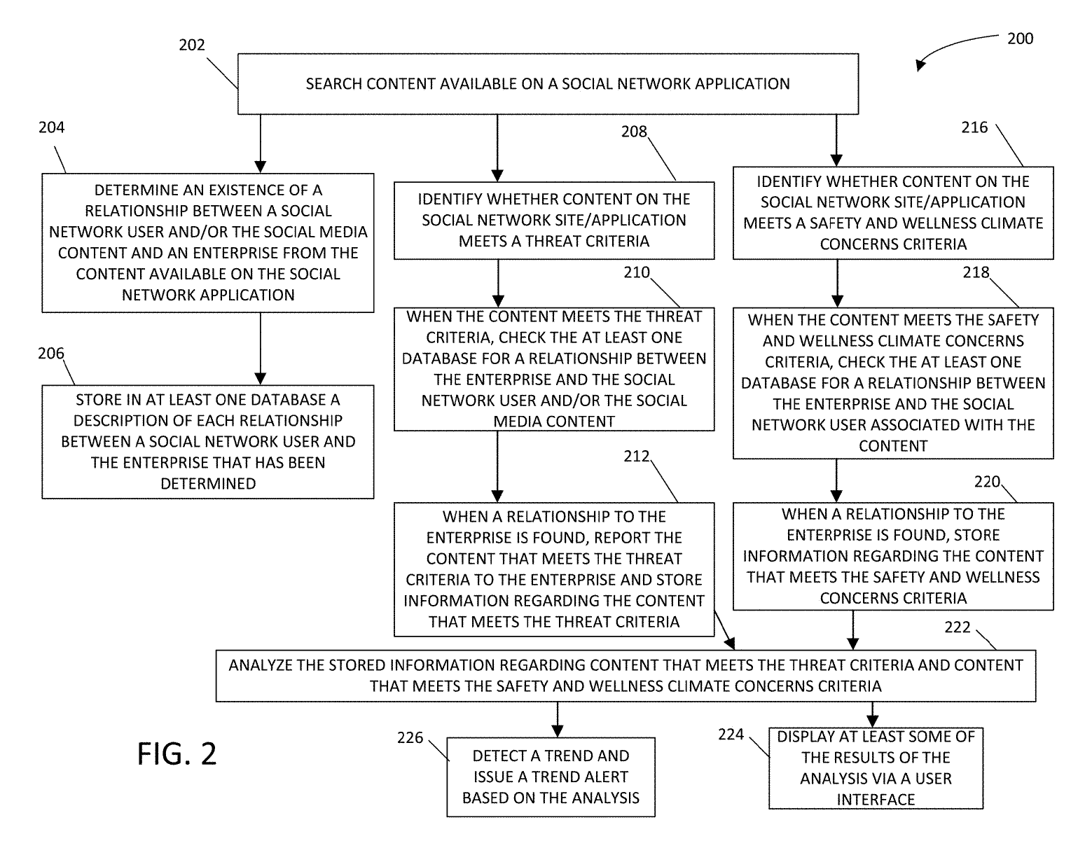

FIG. 2 is a flowchart showing an example method 200 for identifying relationships from social network content to mitigate enterprise safety and security threat concerns and to obtain information regarding safety and wellness climate concerns, according to an example embodiment. The method 200 may be performed using the example system 100 shown in FIG. 1.

In step 202, the content module 110 searches content available on a social network application. In some embodiments, the content module 110 can search content on multiple social network applications, such as Facebook (public pages), Flickr, Google+, Instagram, Meetup, Tumblr, Twitter, Vimeo, YouTube, WordPress, 4chan, Whisper, forums, and others. The content module 110 may assess publicly available content on social network applications including posts, photos, videos, comments, location information, user profile information, and other content. The assessment in step 202 may be continuous or periodic.

In step 204, the relationship module 120 determines an existence of a relationship between a social media content author and/or the social media content and an enterprise from the content available on the social network application. In some embodiments, the existence of the relationship is determined from location information or metadata associated with the content, use of a name of an enterprise by the social network application user, use of a name of a person by the social network application user where the person is associated with an enterprise, the social network application user's connection with a person associated with an enterprise, or a combination of any of the aforementioned. The relationship module 120 may process content from the content module 110 to determine the existence of relationships. This processing of content from the content module 110 by the relationship module 120 may be performed continuously or in batches.

In some embodiments, the existence of a relationship is determined from the location information when the content indicates a geographic location of the social network application user as being near or at the enterprise while generating the content or making the content available to the social network application. Some social network applications allow a social media content author to attach a location to the content based on where the author (or author's device) is physically located when the content is made available on the social network application. Some social network applications automatically attach location information to the content based on where the author (or author's device) is physically located when the content is made available on the social network application. Such information that identifies the physical location of the author when he or she made content available to the social network application is referred to here as location information. When the location information indicates that the author was in proximity of an enterprise, the relationship module 120 determines an existence of a relationship between the author and the enterprise based on the author's proximity to the enterprise when the author made content available in the social network application. Determining the author's proximity to an enterprise may be a configurable element in that a radius in miles or kilometers may be provided that when the author is within that radius, the author is considered in proximity to the enterprise.

Some social network applications allow an author to “check-in” at a location or enterprise. An author may or may not make additional content available while they are checked-in at a location or enterprise. Such check-in information is also referred to here as location information, and the relationship module 120 can determine an existence of a relationship between the author and the enterprise based on the user checking-in at the enterprise or the location of an enterprise.

In some embodiments, the existence of a relationship is determined from the location information or metadata when a user profile of the social network application author is associated with the content indicates a geographic location that is the location of the enterprise or a location near the enterprise. Some social network applications allow a user to maintain a user profile that contains information related to the user, such as demographic information, home address, work address, and the like. In some embodiments, the user profile may include information indicating that he or she lives or works near an enterprise. Such information is also referred to here as location information. The relationship module 120 can determine an existence of a relationship between the author and the enterprise based on the author's profile including location information.

In an example embodiment, the author may include the name of a location or an enterprise in the content that he or she makes available via the social network application. The relationship module 120 determines an existence of a relationship between the author and the enterprise mentioned based on the content. In some embodiments, the author may include the name of a person associated with an enterprise in the content that the author makes available via the social network application. The relationship module 120 determines an existence of a relationship between the author and the enterprise based on the content mentioning a person associated with the enterprise. A person associated with an enterprise, for example, may be an employee of the enterprise, a student of the enterprise, a client of the enterprise, or a fan of the enterprise. Similarly, a person associated with an enterprise, for example, may be a relative of a person associated with the enterprise or a person at or near the enterprise. In some embodiments, a list of persons who are associated with an enterprise may be provided by the enterprise in a database, and the relationship module 120 may query the database to determine whether the content mentions any of the persons on the list.

In some embodiments, information regarding a relationship between the author and the enterprise is used to determine an existence of a relationship between the enterprise and the identified social media content that includes safety and wellness climate concerns.

In some embodiments, information regarding a relationship between the author and the enterprise is used to determine an existence of a relationship between the enterprise and the identified social media content that includes threatening content.

In step 206, the relationship module 120 stores in at least one database the existence of each relationship between an author's social media ID (or the author's social media ID number) and/or social media content and the enterprise that has been determined. It can be appreciated personally identifying information associated with the author is not stored for any period of time. The relationship module 120 may determine an existence of a relationship between multiple social network application authors and an enterprise. The relationship module 120 stores the information relating an author to an enterprise based on content or profile information made available by the author on social network applications as described above with relation to operation 204. As described above, personally identifying information with the author is not stored for any period of time.

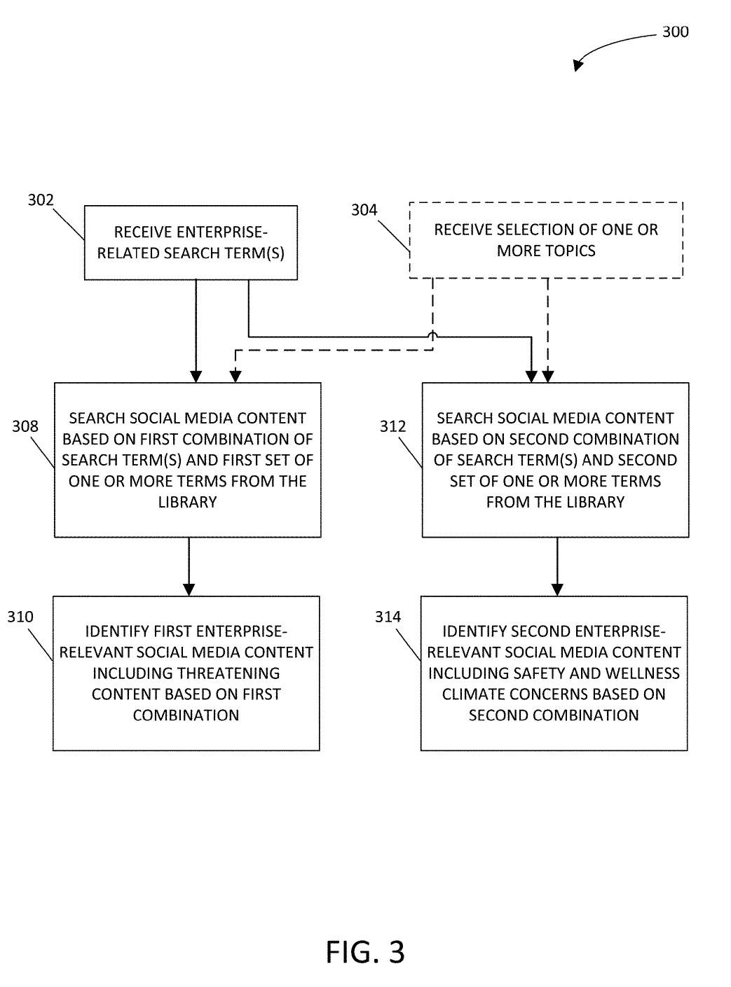

In step 208, which may be carried out concurrently with step 204, at nearly the same time as step 204, or after step 204, the content module 110 identifies whether content available on the social network application meets a threat criteria to identify threatening content. The content module 110 processes social media content and determines whether it meets a threat criteria continuously or in batches. The criteria may be a safety and security threat criteria that, when met, indicates the content includes a threat or relates to a safety and security concern. Any indication of the potential for harm, self-harm, and/or criminal activity that can endanger a person, a group of people, and/or property may satisfy a threat criteria. For example, the criteria may include the content using specific words or demonstrating certain intentions or emotions. A social network content reflecting behavior associated with self-harm, such as an expression of hopelessness, could meet a suicide threat criteria. A social network content reflecting templatized behaviors indicative or associated with mimetic (copycat) acts of violence, such as a well-known assault, would meet a harm threat criteria. For embodiments where one or more enterprise-related search terms are employed, step 208 may be performed as described with respect to method 300 of FIG. 3. Step 208 may include steps 308, and 310.

In step 210, when the content meets the threat criteria, the relationship module 120 queries the database for the existence of a relationship between the author of the content meeting the criteria and an enterprise as determined in step 204.

As described above, in an example embodiment, the existence of a relationship between an enterprise and an author of content and/or the content itself made available on a social network application is determined and a description of the relationship is stored in a database. As described above, personally identifying information with the author is not stored for any period of time. Content meeting a threat criteria is identified, and the database is queried to determine if a relationship exists between the author of the content meeting the criteria and an enterprise.

In another example embodiment, content available on a social network application is searched and content meeting a threat criteria is first identified. Then it is determined whether a relationship exists between an enterprise and the author of the content identified as meeting the criteria. The existence of a relationship can be determined by querying the database that may have stored a description of a relationship between an author and an enterprise. If the database does not indicate or support an existence of a relationship between the author and an enterprise, then existence of a relationship may be determined from the content identified as meeting the criteria (e.g., using various methods described in relation to step 204).

In some embodiments, in step 212, once an existence of a relationship is determined between an author of content that meets the threat criteria and an enterprise, the content meeting the threat criteria is provided to the enterprise. The determination of the relationship identifies the content that meets the threat criteria as enterprise-relevant content that meets the threat criteria. In step 212, when a relationship to the enterprise is found, the description of the relationship between the enterprise and the author of the content that meets the threat criteria may also be provided to the enterprise. With the information from step 212, the enterprise may take appropriate actions to prevent or avoid harm to the enterprise or persons associated with the enterprise. In some embodiments, the information regarding the content that meets the threat criteria is stored for aggregation and analysis with any personally identifying information regarding the author of the content that meets the threat criteria deleted or omitted.

To the extent that content that meets a threat criteria has been identified, but the database reports no relationship between the enterprise and the author of the content, another process may be initiated to look for a possible relationship. Accordingly, step 204 may follow step 210.

In step 216, which may be carried out concurrently with step 208, or at nearly the same time as step 208, the content module 110 identifies whether content available on the social network application meets a safety and wellness climate concerns criteria. Step 216 may be carried out concurrently with step 204, at nearly the same time as step 204 or after step 204. The content module 110 processes social media content and determines whether it meets a safety and wellness climate concerns criteria continuously or in batches. Step 216 may be performed as describe with respect to method 300 of FIG. 3. Step 216 may include steps 312, and 314.

In step 218, when the content meets the safety and wellness climate concerns criteria, the relationship module 120 queries the database for the existence of a relationship between the author of the content meeting the criteria and an enterprise as determined in step 204.

In step 220, when a relationship to the enterprise is found, information regarding the content that meets the safety and wellness climate concerns criteria is stored.

In some embodiments, at least portions of the initial search 202 are set up to selectively provide content that meets a threat criteria or meets safety and wellness climate criteria and is enterprise-relevant or associated with the enterprise. For example, some searches use combinations of one or more enterprise-provided search terms and one or more library terms. As another example, some searches use terms from the library attributes of the social media content that limit the results of the search to enterprise-relevant social media content. The results of such searches are already identified as relevant to the enterprise and the step of checking for a relationship between the enterprise and the social media content or the social media content author such searches may be omitted.

In some embodiments, searches that are limited the results to enterprise-relevant social media content and searches that do not limit the results to enterprise-relevant social medical content are both used, in which case the step(s) of checking for a relationship between enterprise and the social media content author or the social media content may only be performed for results from searches that were not limited to enterprise-relevant social media content.

In step 222, information regarding content that meets the threat criteria and information regarding content that meets the safety and wellness climate concerns criteria is analyzed using the analysis module 150.

In step 224, at least some of the results of the analysis are displayed via a graphical user interface. The results can be transformed into graphs, charts, or other visual indicators. The graphs, charts, or visual indicators can be included on a graphical user interface.

In step 226, the analysis module 150 detects a trend in the information being analyzed and issues a trend alert based on the analysis.

In this manner, the example systems and methods described herein identify relationships between the author of content on a social network application or the social media content itself and an enterprise. Sometimes the relationship can be identified from the content itself because it mentions the name of the enterprise or other enterprise-relevant search terms. Sometimes attributes or metadata of the social media content can be used to identify the relationship. Once a relationship is identified, the enterprise can be notified of the threatening content of concern and of public information regarding the author so that safety and security concerns may be mitigated.

In an exemplary embodiment, the system employs a process that includes searching social media content against terms and phrases provided in a library (i.e., threatening content library of terms and/or safety wellness library of terms) to identify content that includes threatening content or safety and wellness climate concerns, identifying a relationship between the threatening content or content including safety and wellness climate concerns and an enterprise, and generating and transmitting an alert to the enterprise associated with the content including safety and security threat concerns, and/or storing an analyzing information regarding content with safety and wellness climate information. In some embodiments, enterprise-related search terms, at least some of which can be provided by the enterprise, are combined with one or more terms from the library for searching.

In an example embodiment, an enterprise provides a list of pages or usernames of social network applications that are hosted by the enterprise. In some embodiments, some or all of the enterprise information may be provided or updated via a graphical user interface that is also used to display analysis results. Information regarding enterprise-relevant social media content that includes safety and wellness climate concerns information is stored, analyzed and displayed to a user via a graphical user interface. In some embodiments, a trend in the safety and wellness climate concerns content is detected and a trend alert issued based on the analysis.

In an example embodiment, the system searches and analyzes social media content in four compartments, such as bucket, local, local/global and global. The system searches social media content and populates the bucket compartment with content that includes an asset or enterprise specific term (e.g., name of an asset or enterprise), which includes searching using one or more enterprise-related search terms, content that was published or posted within a specified geolocation (e.g., within proximity of an asset or enterprise), or content that includes metadata connecting the author to an asset or enterprise (e.g., the author's social media profile indicates he or she is associated with the asset or enterprise). The content populated in the bucket compartment is generally directly related to an asset or enterprise of interest. The system compares the content within the bucket compartment with the library terms (i.e., threatening content library of terms and/or safety wellness library of terms) and phrases to identify content that includes threat concerns (i.e., threatening content) or safety and wellness climate concerns information. In one embodiment, the compartments can be embodied as data structures. For example, the system can include a bucket data structure, local data structure, local/global data structures, and global data structures. For the bucket compartment, all the content within the bucket compartment is enterprise-relevant content, so no relationship between an author of the social media content and the enterprise or between the social media content and the enterprise needs to be determined in a separate step.

The system populates the local compartment by requesting from the social media providers all posts by an individual who self-references on his or her profile as being from a certain location. The system compares the content within the local compartment with the library terms and phrases (i.e., threatening content library of terms and/or safety wellness library of terms) to identify content that includes safety and security threat concerns (i.e., threatening content) or information regarding safety and wellness climate concerns. In some embodiments, the content in the local compartment deemed to be enterprise-relevant so no relationship between an author of the social media content and the enterprise or between the social media content and the enterprise needs to be determined in a separate step.

The system populates the local/global compartment with social media content that include a threat against an asset or enterprise or information regarding a safety and wellness climate issue. For example, content such as “There is a shooter at UVM” or “I hate school” is stored under the local/global compartment, where the system realizes that UVM refers to University of Vermont. Searches for content with potential threats or safety and wellness climate information to populate the local/global compartment are implemented as rules, which are queries, conducted on the social media provider's server or servers. The system compares the content including potential threats or safety and wellness climate information within the local/global compartment with the library terms and phrases (i.e., threatening content library of terms and/or safety wellness library of terms) to identify content that includes safety and security threat concerns or to identify content that includes safety and wellness climate concerns information.

The system populates the global compartment with social media content that include a threat against a generic asset or enterprise or safety concerns information regarding a generic asset or enterprise. For example, content such as “I′m going to shoot up the school today,” is stored under the global compartment. Searches for content with potential threats or safety concerns information to populate the global compartment are implemented as rules, which are queries, conducted on the social media provider's server or servers. The system compares the content including potential threats or safety concerns information within the global compartment with the library terms and phrases (i.e., threatening content library of terms and/or safety wellness library of terms) to identify content that includes threat concerns and/or safety concerns information. Content stored under the global compartment is also analyzed to identify a relationship between the content author or the content itself and an enterprise or asset. Searching globally for content that meets safety and wellness climate concerns criteria would produce a large volume of results that are not enterprise-relevant. Accordingly, in some embodiments, global searching would be performed for content that meets safety concerns criteria, where the library for safety concerns criteria would be a subset of the library for safety and wellness climate concerns.

FIG. 3 is a flowchart showing an example method 300 performed by the system for identifying security and safety and wellness climate concerns from social media content where one or more enterprise-related search terms are employed. The steps of method 300 may be performed using the example system 100 shown in FIG. 1.

At step 302, the content module 110 receives or accesses one or more enterprise-relevant search terms. In some embodiments, the system runs a system-generated search and the content module 110 receives one or more enterprise-relevant search terms from a database. In an example embodiment, the enterprise-relevant search terms may be stored in the database to run periodic searches of social media content to identify threatening content and safety and wellness climate concerns. In some embodiments, an enterprise may provide words and/or phrases that describe an asset or enterprise of interest to the enterprise, or enterprise user may provide a list of persons associated with the enterprise. For example, in some embodiments, a web form may be used to receive information regarding an enterprise and/or persons or organizations associated with the enterprise. A database of enterprise-relevant search terms may be generated based on these words and/or phrases and list of persons associated with the enterprise. The database of enterprise relevant search terms may be generated by natural language processing of the words, phrases, and list of persons provided by the user

In another example embodiment, the system runs a user-defined or user initiated search, and an enterprise-relevant search term is received by a processor of the device 710 via a graphical user interface 760 displayed on the device 710. The graphical user interface 760 can be rendered on the display 755 of the device 710. In some embodiments, the enterprise or an enterprise user provides information such as keyword, a phrase, a hashtag, which is stored for inclusion as an enterprise-relevant search term for future searches.

The user-relevant search term may include identification of or a definition of various assets or an enterprise of interest that the user of the system wishes to protect or that may be relevant to a safety and wellness climate. For example, the user may define physical locations (such as schools, parks, government buildings, etc.), and/or high profile persons closely related with the enterprise (such as principles, mayors, sheriffs, nicknames for certain persons, or other persons in leadership/high profile positions related to the enterprise etc.). It can be appreciated, the high profile persons closely related with the enterprise are not the authors of the social media content to be searched, but rather may be included in the social media content. The enterprise may provide local terms used in a community (such as local names for drugs, etc. Such local terms used in a community may be used in searching, but results incorporating such terms would not necessarily be enterprise-relevant and the existence of relationship between the resulting social media content and the enterprise would still need to be determined. Information related to the assets, enterprise and local terms is stored in a database and can be used to run system-generated searches of social media content to identify threatening content and safety and wellness climate concerns. The system may initiate system-generated searches of social media at pre-defined times. The search term may include identification of or terms related to an event of interest or a type of event of interest. The search term may include event-based keywords, hashtags, and/or phrases. The event may be a one-time event for which continued searching may not be necessary, or a recurrent event for which ongoing security or safety and wellness searching may be desirable.

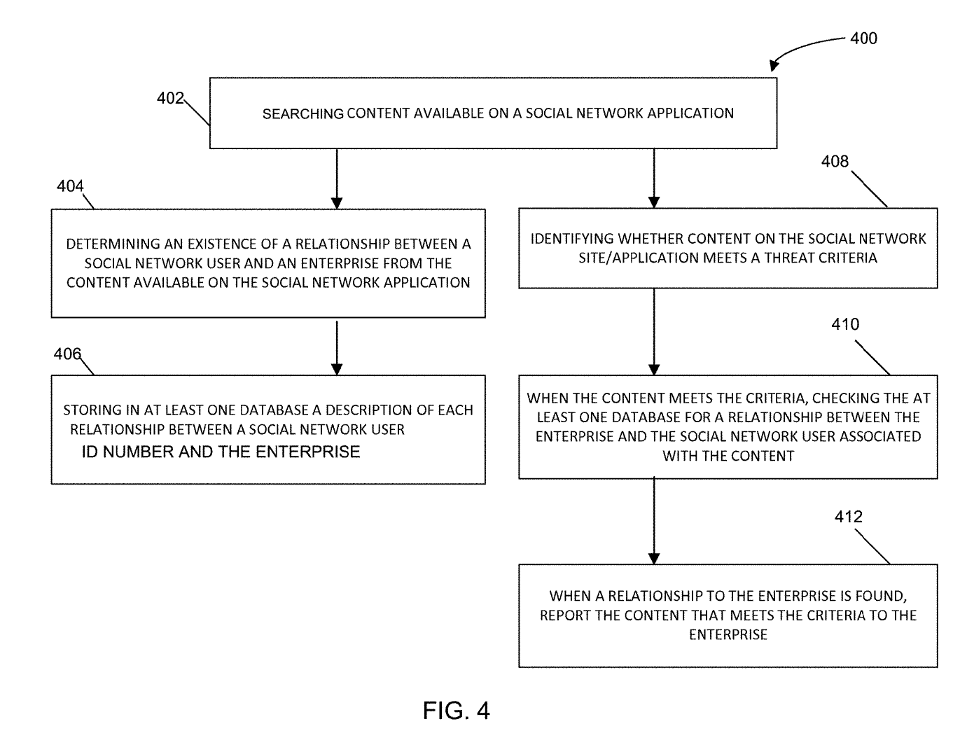

Some embodiments include step 304, in which the content module 110 receives a selection of one or more topics from a library (i.e., threatening content library of terms and/or safety wellness library of terms) stored in a database (for example, database 730 of FIG. 4). Step 304 is shown in dotted lines to indicate that it can be omitted from the method in some embodiments. In embodiments that include step 304, step 302 and step 304 may be performed simultaneously or in a sequential order before the method continues to step 306.

In some embodiments, the user of the system selects one or more topics from the library (i.e., threatening content library of terms and/or safety wellness library of terms) that are relevant to his or her safety or security concern. The user may have previously selected one or more topics of interest from the library (i.e., threatening content library of terms and/or safety wellness library of terms). The system may store information regarding the user's selection for one or more topics of interest and use the stored selection information in current and future searches.

In some embodiments, the system does not receive or require a selection of topics from the library (i.e., threatening content library of terms and/or safety wellness library of terms). The system performs a constrained search of social media content based on all the topics in the library (i.e., threatening content library of terms and/or safety wellness library of terms), generates an alert for social media content including under any or all of the topics in the library (i.e., threatening content library of terms and/or safety wellness library of terms), and performs analysis of safety and wellness climate search results for any or all topics in the library (i.e., threatening content library of terms and/or safety wellness library of terms).

In some embodiments, a selection of one or more topics is received from a user at a later time, for example after step 310, and the system provides the user with alerts or safety and wellness climate information only for the selected topics.

The system includes a library of terms (i.e., threatening content library of terms and/or safety wellness library of terms), including phrases, which is stored in a database. In some embodiments, the terms in the library are grouped by topic (e.g., active shooters; fear anger and anxiety; gangs; harm to others; hate, human trafficking; road safety; self-harm and suicide; child sexual abuse; sexual violence/rape; terrorism; weather related safety; and others). Exemplary topics and terms are described in detail below. A topic may include one or more terms. A term may be included under multiple topics. Within a topic, there may be different lists of terms. In some embodiments, one or more algorithms are associated with each topic. In some embodiments, some of the algorithms describe how to combine the terms under each topic with the enterprise-related search term or terms. As explained above, some terms may be in both safety and security threat concern searches and safety and wellness climate searches, and some terms may only be used in safety and threat concern searches or safety and wellness climate searches. The system employs search terms from the topic or topics in the library so that the search of social media content is constrained to security concerns or information regarding a safety and wellness climate and does not include benign life story of social media users. In some embodiments, the system also searches social media content based on the combination of one or more enterprise-relevant search terms and one or more library terms.

Topics and subtopics may include, but are not limited to, for example, active shooters; fear, anger and anxiety; gangs; harm to others; hate, human trafficking; road safety; self-harm and suicide; child sexual abuse; sexual violence/rape; terrorism; weather related safety; and others. Under the active shooters topic, the stored library terms and phrases may be further categorized into sub-topics, such as fandom and individual. In some embodiments, subject to an agreement or agreements with social media application provider(s) r, a bullying topic may be included. For the bullying topics, the stored library terms and phrases may be further categorized into sub-topics, such as tormentor and victim. Under the terrorism topic, the stored library terms and phrases may be further categorized into sub-topics, such as recruitment and threats. In some embodiments, the topics used security concerns searches are the same as those used for safety and wellness climate searches. In some embodiments, the safety and wellness climate searches may include additional topics. For example, in some embodiments, subject to an agreement with social media application provider(s), the bullying and self-harm and suicide topics may be used for safety and wellness climate searches, but not for security threat concerns searches that are used to issue alerts based on individual posts. The topics searched for security threat concerns and for safety and wellness climate information may vary for different social network application providers. The topics searched for security threat concerns and for safety and wellness climate information may be restricted based on policies or agreements with different social network application providers.

At step 308, the content module 110 searches social media content for threatening content based on a first combination of the enterprise-relevant search term(s) and a first set of one or more terms from the threatening content library of terms In some embodiments, the system 100 can be provided proprietary public social media data from a third party. In some embodiments, the proprietary social media data can include social media data authored by various authored across multiple enterprises and geographic localities. In some embodiments, the proprietary social media data can be data repositories aggregated by the third party. Alternatively, or additionally, the system can opt-in to a service (agreement) for the system 100 to download the proprietary data from a system associated with the third party. In this agreement, the system 100 can download the proprietary data after a specified amount of time intervals or in response to a message from the system associated with the enterprise.

In some embodiments, the content module 110 may be configured to search and review content from the proprietary public social media data provided by the enterprise. The relationship module 120 may be configured to determine an existence of a relationship between a social media content author and an enterprise from the content available on proprietary social media data, and store the existence of a relationship in a database (e.g., as described with respect to steps 204 and 206 in FIG. 2).

At step 312, the content module 110 searches social media content for safety and wellness climate concerns based on a second combination of the search term(s) and a second set of one or more terms from the safety and wellness library of terms stored in a database (for example, database 730 of FIG. 4). In some embodiments, the system 100 can be provided proprietary social media data from a third party. The proprietary social media data can include social media data authored by various authored across multiple enterprises and geographic localities. In some embodiments, the proprietary social media data can be data repositories aggregated by the third party. Alternatively, or in addition to, the system can opt-in to a service (agreement) for the system 100 to download the proprietary data from a system associated with the third party. In some embodiments, the system 100 can download the proprietary public data continuously or periodically, e.g., at specified time intervals, in response to a message from the system associated with the enterprise, etc.

As a non-limiting example, third party can provide proprietary social media data such as an index of human well-being and environmental impact. In some embodiments, the third party can provide the aggregated index of human well-being and environmental impact to the system 100. The content module 110 can search the index of human well-being and environmental impact provided by the third party, for safety and wellness climate concerns using a second combination of the enterprise-related search term(s) and a second set of one or more terms from the library stored in a database.

In some embodiments, the analysis module 150 can aggregate, analyze, and display information related to proprietary social media content identified as being relevant for safety and wellness climate concerns content of the enterprise.

In embodiments that include receiving a selection of one or more topics, the selection may be relevant to or may apply to only the threatening content search, to only the safety and wellness climate concerns search, or to both. In an example embodiment, only the terms under the selected topics are used to perform a constrained search of social media content. In an alternative embodiment, the terms or phrases available in the library (i.e., threatening content library of terms and/or safety wellness library of terms) under each topic are used to perform constrained searches of the social media content across all topics. In this embodiment, only the results of the search that were obtained under the selected topic or topics are delivered in a threat alert to the user of the system or are included in the information to be aggregated and analyzed. For example, a user may select topics for which he or she wishes to receive threat alerts, such as, active shooters, and harm to others. Although the system performs a constrained search of social media content g using terms and phrases in the library (i.e., threatening content library of terms and/or safety wellness library of terms) across all the topics, the user of the system only receives alerts for threatening content that falls under the topics of active shooters and harm to others. As another example, a user may select topics for which he or she would like to view or have access to aggregated and analyzed information regarding safety and wellness climate concerns, such as happiness and self-harm. Although the system performs a constrained search of social media content for safety and wellness climate concerns using the terms and phrases in the library (i.e., threatening content library of terms and/or safety wellness library of terms) across all the topics, the user of the system only has access to or views aggregation and analysis results of safety and wellness climate concerns data that falls under the topic of happiness and self-harm. Searching across all topics may be more computationally intensive for searches of interest to one particular user, in the event that multiple users are interested in potential threats or safety and wellness climate concerns regarding an enterprise or closely related enterprises in different topics, performing the searching across all topics enables results regarding the enterprise to be used and user-selected topic-specific results selected from the results for all topics to be delivered to multiple different users, thereby increasing the overall efficiency of the system in some embodiments. With respect to information regarding safety and wellness climate concerns, multiple different topics may be searched, and analysis and results displayed may depend on a user selection or assignment by a user's superior of topics.

In some embodiments, no selection of topics is received and the system searches across all topics and provides analysis regarding safety and wellness concerns and/or threat alerts for all topics.

In some embodiments, the library (i.e., threatening content library of terms and/or safety wellness library of terms) includes lists of nouns, verbs and/or phrases for at least some of the topics. Depending on the topic, the library (i.e., threatening content library of terms and/or safety wellness library of terms) may also include additional lists of topic-specific terms, for example the hate topic also includes ‘vulnerable’ terms that indicate terms used in threats directed to a person from a vulnerable population (see example involving the hate topic below).

Depending on the topic and whether the search is a safety and security threat concerns search or a safety and wellness climate concerns search, the system uses one or more algorithms to combine an enterprise-relevant search term with the one or more terms/phrases from the library (i.e., threatening content library of terms and/or safety wellness library of terms) for searching purposes. One of the algorithms associated with a topic may be an exact phrase search, where the received search term is combined with an exact phrase, and the social media content is searched for the search term and the exact phrase (see harm to others example below). Another algorithm associated with a topic may be sentence structure search, where social media content is searched for a term indicating a member of a vulnerable population in relatively close proximity (for example within 3-4 words) to a verb on a list of relevant verbs or to a noun on a list of relevant nouns (see hate topic example below). Yet another example algorithm is keyword search, where an enterprise-relevant search term is combined with another term from the library (i.e., threatening content library of terms and/or safety wellness library of terms), and social media content is searched for the enterprise-relevant search term and the library term. In some embodiments, under the keyword search algorithm, the received enterprise-relevant search term and the library term are within close proximity to one another, for example, within 3 to 5 words, or within 4 words. If the enterprise-relevant search term and the library term are separated by 10 or more words, then it may not indicate a safety and security threat, but it may be relevant for safety and wellness climate information. A topic may be associated with more than one algorithm, and a particular algorithm may be associated with more than one topic. For the same topic, the threatening content searches and the safety and wellness climate concerns searches are described by different templates, where each template sets forth how to search based on a combination of one or more search terms and one or more library terms.

In addition to the topics, and the lists of terms and phrases, the library can also include an exclusion list. The exclusion list includes terms that may be excluded when a specific term (a search term or a library term) is searched. For example, if the term “shoot” is searched, the system performs the search while excluding results with photo in close proximity to shoot (e.g., excluding “photo shoot”). In this example, the exclusion list includes the term “photo” as associated with the term “shoot,” and when “shoot” is received as a search term or as a term from the library to combine with the received search term, the system excludes “photo shoot” as indicated by the exclusion list. As another example, the exclusion list may include multiple terms associated with the term “delta.” For example, a user may want to search for “delta airlines.” A search term such as delta can trigger results that include Greek organization names consisting of delta. In this case, the exclusion list includes “delta sigma theta” and “delta delta” as associated with the term “delta.” When “delta airlines” is received as a search term, the system excludes “delta sigma theta” and “delta delta delta” from the search as indicated by the exclusion list.

The search for threatening content in step 308 and the search for content including safety and wellness climate concerns in step 312 are conducted concurrently in some embodiments, are conducted simultaneously in some embodiments and are conducted separately in some embodiments. In some embodiments, the system may search content on multiple social media applications, such as Facebook (public pages), Flickr, Google+, Instagram, Meetup, Tumblr, Twitter, Vimeo, YouTube, WordPress, 4chan, Whisper, forums, and comments.

At step 310, the content module 110 identifies first enterprise-relevant social media content that includes threatening content based on the first combination of the one or more enterprise-relevant search terms and a first set of one or more terms from the threatening content library of terms. At step 314 the content module 110 identifies second enterprise-relevant social media content that includes safety and wellness climate concerns based on the second combination of the one or more enterprise-relevant search terms and the second set of one or more terms from the safety and wellness library of terms. In a non-limiting example, a user may want to identify threat concerns related to an event such as “a nude bike ride” in Vermont. An enterprise can provide search terms (e.g., keywords related to the event), the system combines the search terms with terms from the library that indicate threatening language for an event, and the system searches social media content based on the search terms and the one or more library terms to identify safety and security threat concerns.

In some embodiments, no enterprise-relevant search terms are used in the initial search, and a relationship between social media content from the search and the enterprise is determined after the search.

In some embodiments, the system generates an alert to the user of the system when social media content is identified as including threatening content as described with respect to method 200 of FIG. 2, in particular, according to step 212.

In an example embodiment, the relationship module 120 identifies a relationship between the author of the social media content that indicates a safety and security threat concern and an enterprise, as described in relation to method 200 of FIG. 2.

In an example embodiment, the alert module 130 generates and transmits an alert to the enterprise identified as associated with the content including safety and security threat concerns.

As a non-limiting example, the following content is assessed and considered: “Don't go to school tomorrow, I′m going to blow it up.” The system described here determines an existence of a relationship between the enterprise, Ridgefield High School, and the author of the content based on the content available on a social network application. This relationship is stored in a database. As described above, any personally identifying information associated with the author is stripped, redacted or deleted and not stored for any period of time. In this example, the library terms may include “don't go to school” or “blow it up” and the search term may be Ridgefield High School. Based on the identification that the content meets a threat criteria, meaning that it is threatening content, (method step 208 and method steps 308-310) and establishing a relationship between the author and the enterprise (method steps 210 and 212), the content is reported (e.g., a threat alert is sent).

As another non-limiting example, the following content is identified and considered: “I hate working at the hospital.” The system described here determines an existence of a relationship between the enterprise, Springfield General Hospital, and the author of the content based on the content in a social networking application mentioning the name of the enterprise. A description of this relationship is stored in a database, however, a threat alert for this content is not provided to Springfield General Hospital because the content relates to the author's benign life story and does not rise to a security or safety concern. For example, the system described herein does not identify this example social media content as a result of interest because combining one or more library terms with the search terms does not produce this content as a result of interest.

As another non-limiting example, the following content is identified and considered: “I'm going to kill John Smith.” John Smith may be on a list of persons associated with an enterprise, for example, Springfield General Hospital. The system described here determines an existence of a relationship between the enterprise, Springfield General Hospital and the author of the content based on the content mentioning the name of a person associated with an enterprise.

The system would detect this content as including an enterprise-relevant threat based on the combination of the library term “kill” with a person having a relationship with the enterprise, which in this case may be John Smith. Based on the detected threat and the established relationship between target and the enterprise, a threat alert would be sent (e.g., Springfield General Hospital would be provided the content and the description of the relationship of the content to Springfield General Hospital).

As another non-limiting example, the following content is identified and considered: “I love John Smith.” John Smith may be on a list of persons associated with an enterprise, for example, State University. The system described here determines an existence of a relationship between the enterprise, State University, and the author of the content based on the content mentioning the name of a person associated with an enterprise. This content would not match any of the library terms and so would not be identified as content that includes a safety or security concern. A description of this relationship is stored in a database, however, an alert for this content would not be provided to State University because the content relates to the author's benign life story. As described above, any personally identifying information associated with the author is stripped, redacted or deleted and not stored for any period of time.

As another non-limiting example, the following content is identified and considered: “I am taking a gun to school tomorrow.” In this example the library terms would be “gun” in proximity to “school” and the content would meet the threat criteria. According to the user profile of the author of the content, he goes to school at Community College. The system described here determines an existence of a relationship between the enterprise, Community College, and the author of the content based on his user profile indicating that he frequents the enterprise because he attends school there. A description of this relationship is stored in a database, and Community College would be provided a threat alert on this content and the relationship. As described above, any personally identifying information associated with the author is stripped, redacted or deleted and not stored for any period of time.

As another non-limiting example, the following content is identified and considered: “I hate this place.” This content has location information associated with it because the author made it available at a particular geographic location that was stored by the social network application. The geographic location is that of the Best Hotel and Resort. The system described here determines an existence of a relationship between the enterprise, Best Hotel and Resort, and the author of the content based on the location information associated with the content. A description of this relationship is stored in a database, however, an alert for this content would not be provided to Best Hotel and Resort because the content does not match any terms in the library and would not be identified as social media content that includes safety and security concerns. As described above, any personally identifying information associated with the author is stripped, redacted or deleted and not stored for any period of time.

As another non-limiting example, the following content is identified and considered: “I am going to kill my boyfriend.” According to the author's social network connections, John Smith is the author's boyfriend. John Smith is on the list of persons associated with the enterprise, corporation or employee. The system described here determines an existence of a relationship between the enterprise, corporation or employee, and the author of the content based on the author's social network connection with a person associated with the enterprise. A description of this relationship is stored in a database. Based on the library term “going to kill” in proximity to a person, this content would be identified as including threatening content and corporation or employee, is be provided a threat alert on this content and the description of its relationship to Townville Municipality. As described above, any personally identifying information associated with the author is stripped, redacted or deleted and not stored for any period of time.

Some the terms and phrases included in the library indicate language and behaviors that are predictive of bad outcomes (generally safety or security concerns of the wellness of an enterprise, an enterprise's assets or enterprise's community). These predictive concerns are coded in the library. In some embodiments, the terms and phrases to be included in the library are selected by analyzing various safety and security situations that have occurred and data mining threatening language and words that may indicate safety and security threat concerns. In some embodiments, safety and security experts, such as law enforcement, mental health professionals, anti-terrorism task forces, etc., may be consulted to determine which terms are included in the library. Additionally, the library also includes terms that appeared in social media content generated by or associated with persons who were involved in initiating safety and security concerns in the past.

The library may include templates organized by topics. In some embodiments, a template may include a collection of some or all of keywords, hashtags, phrases, etc. and natural-language-processing (NLP) protocol and algorithm which connects the terms in the library under a specific topic with the search term(s) entered or provided by the user. In this manner, the library includes terms that can aid in identifying threats, threatening language, safety and security concerns against another person, the enterprise or the general public as well as safety and wellness climate concerns.

In some embodiments, the library terms may specify terms that are not searched for or should not be included in social media content results that indicate a safety or security concern. For example, if the term “shoot” is in the library of terms, searches incorporating the word “shoot” would be structured not to target results where “shoot” is near the word “photo” to avoid drawing in results solely directed to a photography shoot.

In an example embodiment, a social media provider may prohibit searching of certain terms. For example, social media provider ‘A’ may not allow searching for the term “bully” or “bullying.” In this case, the system is configured to not search for the term “bully” or “bullying” when searching social media content available via the social media provider ‘A.’

Various non-limiting examples are described now to illustrate the use of the system and the library of terms. In a non-limiting example, the an enterprise user of the system may want alerts or analysis regarding threatening content or safety and wellness climate concerns that fall under the hate topic of the library. In this example, the enterprise user selects the hate topic and the system retrieves an enterprise-related search term from a database based on asset definition or information provided by the user. For example, the enterprise or an enterprise user may have provided a name of a school or a university campus name or location as definition of an asset of interest. This asset information is combined with terms under the hate topic as explained below to perform a constrained search of social media content for threatening content or safety and wellness climate concerns.

In this example, terms include profanity and offensive terms for people in various vulnerable populations. The profanity is included because it is commonly employed in threats. The offensive terms for people in vulnerable populations are included because such offensive terms are employed in threats against members of the vulnerable populations and the use of offensive terms for vulnerable populations is a safety and wellness climate concern. In this description, certain letters will be replaced with asterisks for some of the particularly profane or offensive terms; however, the full words without asterisks appear in the library and are employed in searches.

Under the hate topic, the system searches for threats in two forms. For example, one form is [some threatening verb] near [a person from a vulnerable population]. Another form is [some weapon] near [a person from a vulnerable population]. In an example embodiment, the hate topic includes three lists of terms: vulnerable, nouns, and verbs. The hate topic vulnerable list of terms includes, but is not limited to: fag, faggot, queer, gay, lesbian, lesbo, dike, ni**er, jew, kike, heeb, spade, school, church, synagogue, mosque, and other terms or slurs that may be used to describe the previous terms in an offensive manner The hate topic verbs list of terms includes, but is not limited to: f*ck, kill, beat, beating, burn, die, rape, knife, shoot, shoots, bust, crack, cut, bomb, and may include other terms or slang used as threatening verbs. The hate topic nouns list of terms includes, but is not limited to: glock, colt, AK, fist, bomb, and other terms or slang used to describe weapons.

Continuing with the non-limiting example, the system searches social media content to identify content that includes a target and a threatening action, where the target term and the threatening action terms are fairly close to each other, for example approximately within 3 to 5 words of each other or within 4 words of each other. If the target and threatening word are separated by 10 or more words, then it may not be considered fairly close and may not indicate a safety and security threat; however, such content may be pulled in by a safety and wellness climate concerns search. The target term is selected from the vulnerable list and the threatening action term is selected from the verbs list under the hate topic. Similarly, the system also searches social media content to identify content that includes a target from the vulnerable list and a noun from the nouns list under the hate topic.

In another non-limiting example, the library includes a topic called harm to others. Under the harm to others topic, the library includes phrases from real-world examples where a person or persons published social media content with threatening language and then were involved in initiating the safety or security concern indicated in the content. For example, the phrases under the harm to others topic may be selected based on school shootings that have occurred in the past. The harm to others topic may include phrases like, but is not limited to, “will be your bloody head,” “will I see it to the end,” “won't see them again after tomorrow morning,” “you all make me sick,” “you are sending your most hated place to hell,” “you have to sacrifice them,” “you need to die now,” “you need to die too for being white,” “you won't see me coming,” and other variations of these phrases.

As another example, the sexual violence/rape topic may include phrases like, but not limited to, “was raped” or “was drugged.”

As described above, the system may employ enterprise-related search terms, which can be based, at least in part on information related to or defining assets that the enterprise wishes to protect from threats or assets that may affect or be relevant to the enterprise's safety or wellness climate. To limit false positives in the results and to ensure that the system outputs results that are not about a social media user's benign life story, but rather about safety and security issues or information relevant to a safety or wellness climate concern, the system constrains searches of social media content with information from the library. Based on enterprise-related asset information, the system selects terms from the library for combination. For example, asset information like “city hall” may be combined with “bomb” for searching social media content for threatening content. Asset information that relates to an event where a large number of people may attend may be combined with one or more terms from the ‘Harm to Others’ topic of the library. Such event based enterprise-related search terms may also be combined with one or more terms from the hate topic.

In some embodiments, the system described herein performs complex forms of searching social media content to identify content including safety and security threat concerns and content including safety and wellness climate concerns. For example, one non-limiting complex form includes searching content that includes or indicates bullying concerns. People in crisis have often have been bullied. It is important for an institution of education, for instance, to know if a student or person associated with the institution is being bullied. One or more key events may also predict bad outcomes. When a person who is being bullied validates or accepts what the bully or bullies say, he or she is much more likely to act either inwardly (harm oneself) or outwardly (harm others). Thus, searches for security threat concerns may incorporate determining when the person who is bullied validates or accepts what the bully or bullies say, while searches for safety and wellness climate concerns may not require determining whether the person who is bullied validates or accepts what the bully or bullies say.

In some embodiments, subject to an agreement with the social media application, the system includes exemplary models for victims and tormentors based on past observed behavior of known victims and tormentors. The system maintains statistics and data on victims and tormentors that may help identify a safety and security threat concern or safety and wellness climate concerns. For example, the system may identify various social media content that directs a certain amount of negative sentiment towards a victim, and in response, the system generates and transmits an alert. The system may identify social media content where the victim validates or accepts the language used by the bully, and in response, the system generates and transmits another alert. The system accomplishes this task by identifying tormentor language within social media content, identifying a relationship between the tormentor and victim, and then identifying the victim's response in social media content.

In some embodiments, subject to an agreement with a social media application, the library includes a topic called bullying, and the bullying topic may include sub-topics called victim and tormentor. The sub-topic victim may include terms including phrases that relate to a person that receives negative sentiment. The sub-topic tormenter may include terms including phrases that relate to a person that projects negative sentiment towards another person. Using the library topic bullying, the system identifies social media content that relates to bullying, and identifies a victim and a tormentor from the social media content. The library topic of bullying aims to avoid identifying social media content that includes benign negative comments or words that do not rise to the level of bullying. In an example embodiment, the system searches for social media content that references another social media author and includes language such as, but not limited to, “just commit suicide,” “you are a failure,” “you are insignificant,” “you are not loveable,” “you are shameful,” “you are stupid,” “you are ugly,” “you are worthless,” other terms, or any combination of these terms. Such content is identified as including a bullying concern. The author of such content may be identified as the tormentor, and the person identified or referenced in the content may be identified as the victim.

In some embodiments, subject to an agreement with a social media application, the system records a combination of tormentors and victims in a database. For example, there may be multiple tormentors directing negative sentiment towards one victim, there may be one tormentor directing negative sentiment towards one victim multiple times, there may be one tormentor directing negative sentiment towards multiple victims, or there may be multiple tormentors directing negative sentiment towards a set of victims.

Once content including bullying concerns is identified, the system identifies a relationship between the victim and an enterprise, and generates a trend alert and transmits it to the associated enterprise. In some embodiments, if a relationship between the victim and an enterprise cannot be identified, then the system identifies a relationship between the tormentor and an enterprise. In an example embodiment, a trend alert is generated and transmitted when the instances of content including bullying concerns against a single victim exceeds a threshold or predefined number. In one example, the alert identifies the victim, but does not identify the tormentor(s), because the objective is mitigate a bad outcome with respect to the victim and not to prosecute the tormentors.

In an example embodiment, the system generates and transmits an alert based on social media content in which the victim validates the negative sentiment directed towards him or her, which indicates that the victim is likely in crisis. Such content may include language such as, but not limited to, “I am a failure,” “I am insignificant,” “I am ugly,” “I am not loveable,” “I want to die,” “I′m sorry,” “I apologize,” other terms or phrases, or any combination of these terms or phrases.

Additionally, conventional systems analyze all content related to an enterprise. In contrast, the system described herein only analyzes content that meet a certain criteria as defined by the library of terms and phrases that relate to safety threat concerns and safety and wellness climate concerns. As such, the system described herein is more efficient in terms of time and resources.

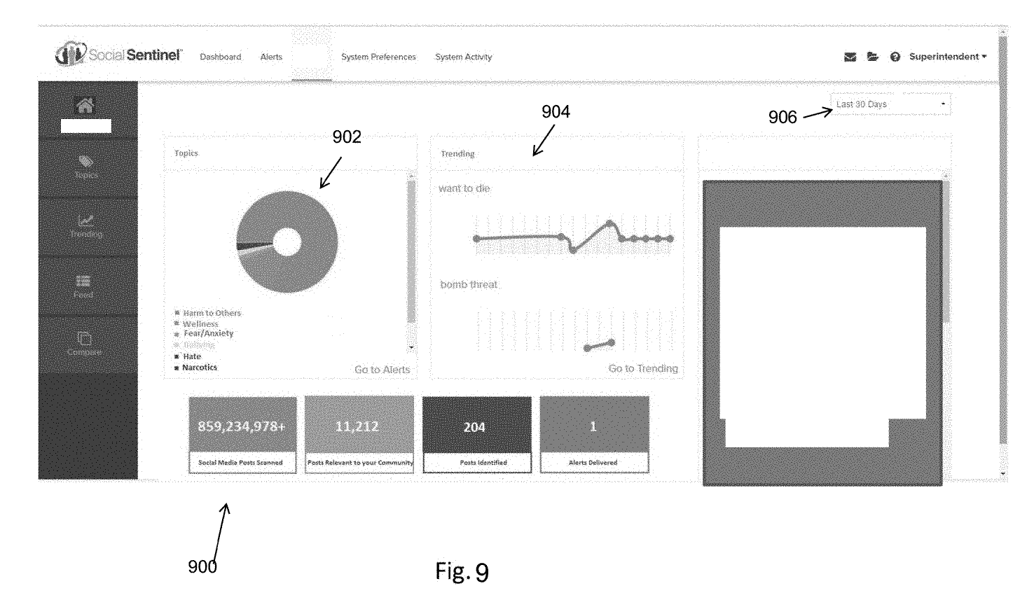

Various non-limiting examples of the analysis and display based on information from the safety and wellness climate concern searches and the threatening content searches are shown in FIGS. 9-14. FIG. 9 shows a graphical user interface 900 including a pie chart 902 of items for the various topics in the last 30 days. Also included is an indication of trends 904 for some key words. A drop down box 908 in the upper right portion of the interface enables a user to view results and analysis for content from a different selected time period. In some embodiments, results regarding more than one topic may be grouped together for some aspects of analysis and display (e.g., information regarding some topics like “self-harm and suicide” may be grouped together under a wellness label for safety and wellness climate analysis and display).

FIG. 10 includes a graphical user interface 1000 with a graph showing how the volume of items (e.g., posts) varied over time 1002 for different topics. It includes a doughnut chart 703 showing how the various topics contributed to the total number of items over the time period. It also includes a graphical word cloud 1004 of popular terms from the posts. In some embodiments, the word cloud 1004 is based, in part, on information stored short term (e.g., 2 days, 14 day, 30 days) for the safety and wellness climate concern search results. As described above, in some embodiments, information such as the content of the items and keywords is not stored long term and so a word cloud could not be generated for content that is older than the short term storage period.

FIG. 11 shows a graphical user interface 1100 including a graph 1102 illustrating a comparison of volume of posts for various topics over a period of one week.

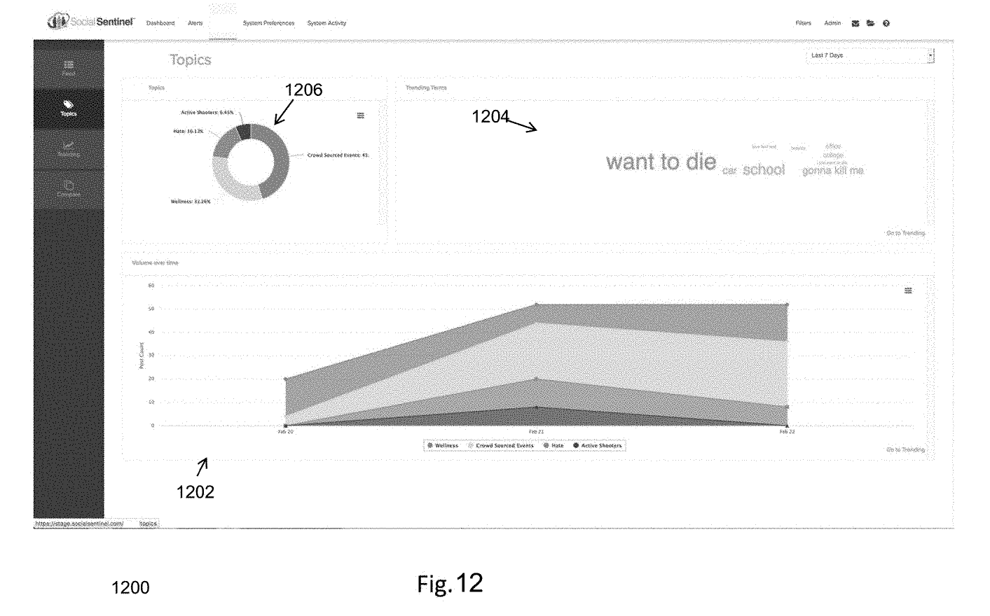

FIG. 12 shows a graphical user interface 1200 including a graph 1202 showing cumulative numbers of items over the course of a week with different colors indicating how the different topics contribute to the total number of items. The interface also includes a graphical word cloud 1204 of trending terms and a doughnut chart 1206 showing how each topic contributes to the total number of items over the course of the selected time period of the last 7 days.

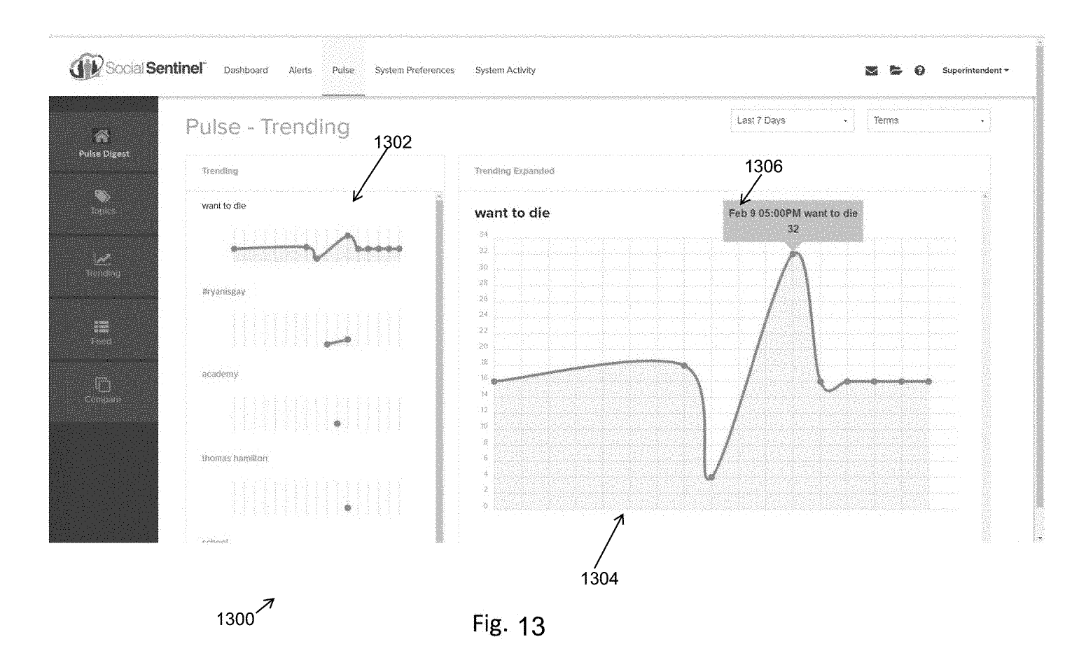

FIG. 13 shows a graphical user interface 1300 including a listing 1302 of terms or phrases that trended in the last 7 days and an expanded graph 1304 of the total volume of items for the phrase “want to die” over the last seven days. In embodiments that employ short term stored data and smaller subset of long term stored data, the trending analysis may be based on the short terms stored data as the long term data may not include the keywords or phrases used in individual items from the safety and wellness climate searches. In one embodiment, a callout 1306 can be rendered on the graph, in response to scrolling to a point in the graph 1304 using a pointing device (i.e., mouse) or a human digit.

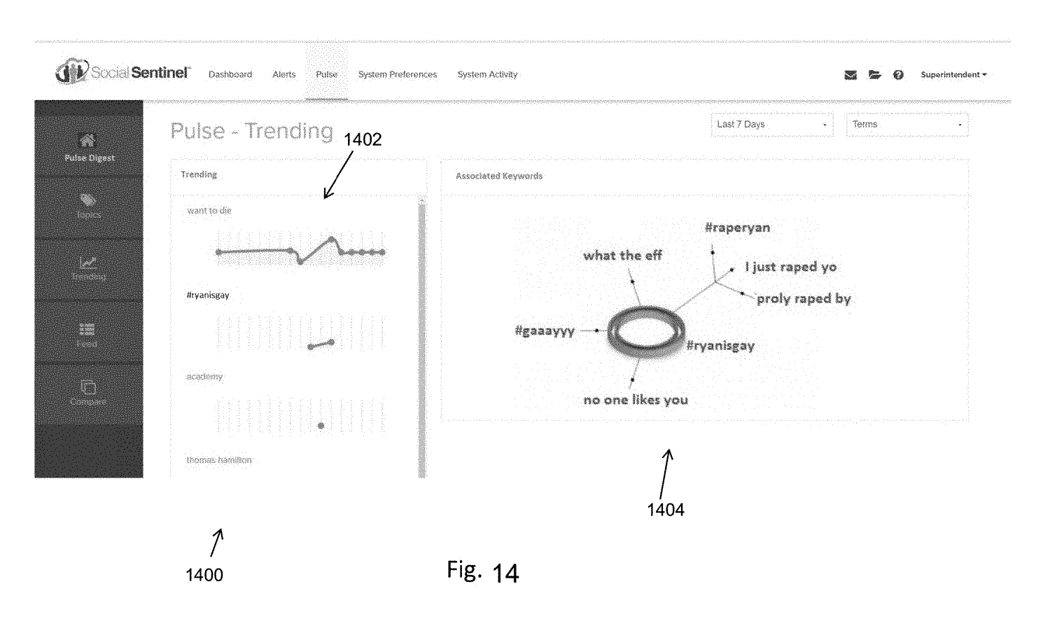

FIG. 14 shows an example of a graphical user interface 1400 including a listing 1402 of trending topics and a graphical indication 1404 of associated keywords. The listing 1402 can be rendered on in a left window or frame. The graphical indication 1404 can be rendered in a right window or frame.

FIG. 4 is a flowchart showing an example method 400 for identifying relationships from social network content to mitigate enterprise safety and security concerns, according to an example embodiment. The method 400 may be performed using the example system 100 shown in FIG. 1. The method 400 is described in PCT application: PCT/US2015/062432, which is incorporated herein by reference in its entirety. Use of the method to determine the existence of a relationship between a social media content author and an enterprise as described below also determines the existence of a relationship between the social media content and the enterprise. In embodiments described with respect to FIG. 4 below, personally identifying information regarding the author of the social media content is not stored.

In step 402, the content module 110 searches content available on a social network application. In step 402, embodiments of content module 110 do not filter the available content based on meeting a threat criteria. In some embodiments, the content module 110 can search content on multiple social network applications, such as Facebook, Flickr, Google+, Instagram, Meetup, Tumblr, Twitter, Vimeo, YouTube, WordPress, 4chan, Whisper, forums, and comments. The content module 110 may search publicly available content on social network applications. The searching of step 202 may be continuous or periodic.

In step 404, the relationship module 120 determines an existence of a relationship between a social network application author and an enterprise from the content available on the social network application. The existence of the relationship is determined from either location information associated with the content, use of a name of an enterprise by the author, use of a name of a person by the social network application author where the person is associated with an enterprise or the author's connection with a person associated with an enterprise. The relationship module 120 may process content from the content module 110 to determine the existence of relationships continuously or in batches.

In some embodiments, the existence of a relationship is determined from the location information when the content indicates a geographic location of the author as being near or at the enterprise while generating the content or making the content available to the social network application. Some social network applications allow an author to attach a location to the content based on where the author (or author's device) is physically located when the content is made available on the social network application. Some social network applications automatically attach location information to the content based on where the author (or author's device) is physically located when the content is made available on the social network application. Such information that identifies the physical location of the author when he or she made content available to the social network application is referred to here as location information. When the location information indicates that the author was in proximity of an enterprise, the relationship module 120 determines an existence of a relationship between the author and the enterprise based on the author's proximity to the enterprise when the author made content available in the social network application. Determining the author's proximity to an enterprise may be a configurable element in that a radius in miles may be provided that when the user is within that radius, the author is considered in proximity to the enterprise.

Some social network applications allow an author to “check-in” at a location or enterprise. A author may or may not make additional content available while they are checked-in at a location or enterprise. Such check-in information is also referred to here as location information, and the relationship module 120 can determine an existence of a relationship between the author and the enterprise based on the author checking-in at the enterprise or the location of an enterprise.

In some embodiments, the existence of a relationship is determined from the location information when a user profile of the author is associated with the content indicates a geographic location that is the location of the enterprise or a location near the enterprise. Some social network applications allow an author to maintain a user profile that contains information related to the author, such as demographic information, home address, work address, and the like. In some embodiments, the user profile may include information indicating that he or she lives or works near an enterprise. Such information is also referred to here as location information. The relationship module 120 can determine an existence of a relationship between the author and the enterprise based on the author's profile including location information.

In an example embodiment, the author may include the name of a location or an enterprise in the content that he or she makes available via the social network application. The relationship module 120 determines an existence of a relationship between the author and the enterprise mentioned in the content. In some embodiments, the author may include the name of a person associated with an enterprise in the content that he or she makes available via the social network application. In some embodiments, a list of persons who are associated with an enterprise may be provided in a database, and the relationship module 120 may query the database to determine whether the content mentions any of the persons on the list.

The relationship module 120 can also determine an existence of a relationship between the author and an enterprise based on the author's social network connection with a person associated with the enterprise. Some social network applications allow an author to “connect” with other authors of the social network application. For example, the author associated with the content available on the social network application may have a social network connection in the social network application with a person associated with the enterprise. A person associated with an enterprise, for example, may be an employee of the enterprise. The relationship module 120 can use this information to determine an existence of a relationship between the author and the enterprise.

In step 406, the relationship module 120 stores in at least one database the existence of each relationship between an author's social media id (or social media id number) and the enterprise that has been determined. As noted above, personally identifying information regarding the author of the social media content is not stored. The relationship module 120 may determine an existence of a relationship between multiple authors and an enterprise. The relationship module 120 stores the information relating an author to an enterprise based on content or profile information made available by the author on social network applications as described above with relation to operation 404.

In step 408, which may be carried out concurrently with step 204 or at nearly the same time as step 404, the threat module 130 identifies whether content available on the social network application meets a threat criteria. The threat module 130 may process content from the content module 110 to determine whether it meets a threat criteria continuously or in batches. The criteria may be a security criteria that when met indicates the content includes a threat or relates to a safety and security concern. Any indication of the potential for harm, self-harm, and/or criminal activity that can endanger a person, a group of people, and/or property may satisfy a threat criteria. For example, the criteria may include the content using specific words or demonstrating certain intentions or emotions. A social network content reflecting behavior associated with self-harm, such as an expression of hopelessness, would meet a suicide threat criteria. A social network content reflecting templatized behaviors indicative or associated with mimetic (copycat) acts of violence, such as a well-known assault, would meet a harm threat criteria.

In step 410, when the content meets the criteria, the threat module 130 queries the database for the existence of a relationship between the author of the content meeting the criteria and an enterprise as determined in step 404.

As described above, in an example embodiment, the existence of a relationship between an enterprise and an author of content made available on a social network application is determined and a description of the relationship is stored in a database. Then content meeting a threat criteria is identified, and the database is queried to determine if a relationship exists between the author of the content meeting the criteria and an enterprise.

In another example embodiment, content available on a social network application is monitored and content meeting a threat criteria is first identified. Then it is determined whether a relationship exists between an enterprise and the author of the content identified as meeting the criteria. The existence of a relationship can be determined by querying the database that may have stored a description of a relationship between an author and an enterprise. If the database does not indicate or support an existence of a relationship between the author and an enterprise, then existence of a relationship may be determined from the content identified as meeting the criteria (using various methods described in relation to step 404), or from past content made available by the author on the social network application (using various methods described in relation to step 204).

In some embodiments, in step 412, once an existence of a relationship is determined between an author of content that meets the criteria and an enterprise, the content meeting the criteria is provided to the enterprise. In step 412, when a relationship to the enterprise is found, the description of the relationship between the enterprise and the author of the content that meets the criteria may also be provided to the enterprise. With the information from step 412, the enterprise may take appropriate actions to prevent or avoid harm to the enterprise or persons associated with the enterprise.

In this manner, the systems and methods described herein provide a method, system, and computer readable medium to identify relationships between the author of content on a social network application and an enterprise. Sometimes the relationship can be identified from the content itself because it mentions the name of the enterprise. Once a relationship is identified, the enterprise can be notified of the content of concern and of the user of concern so that safety and security concerns may be mitigated.

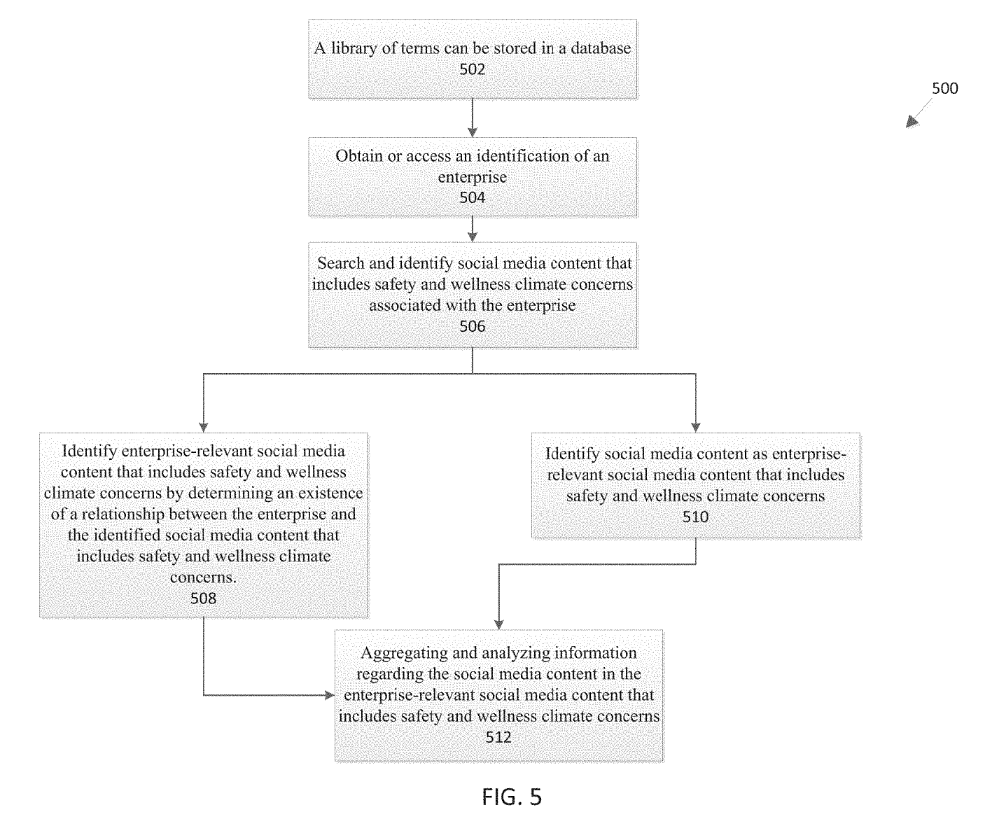

FIG. 5 is a flowchart showing an example method 500 for identifying safety, and wellness climate concerns from social media content. In step 502, a library of terms can be stored in a database. The library of terms can include terms to constrain searching of social media content to safety and wellness climate concerns. In step 504 the system 100 can obtain or access an identification of an enterprise.

In step 506, the content module 110 can search and identify social media content that includes safety and wellness climate concerns associated with the enterprise, based on one or more of the following: detection of one or more terms from the library of terms associated with safety concerns in the social media content in response to an execution of a search, detection of one or more terms from the library of terms and one or more attributes in the social media content in response to an execution of a search, or detection of a combination of one or more enterprise-related search terms and one or more terms from the library of terms in the social media content in response to an execution of a search.

In some embodiments, the content module searches and identify social media content that includes safety and wellness climate concerns associated with the enterprise, based on two or more of the following: detection of one or more terms from the library of terms associated with safety concerns in the social media content in response to an execution of a search, detection of one or more terms from the library of terms and one or more attributes in the social media content in response to an execution of a search, or detection of a combination of one or more enterprise-related search terms and one or more terms from the library of terms in the social media content in response to an execution of a search.

In some embodiments, the content module searches and identify social media content that includes safety and wellness climate concerns associated with the enterprise, based on all three of the following: detection of one or more terms from the library of terms associated with safety concerns in the social media content in response to an execution of a search, detection of one or more terms from the library of terms and one or more attributes in the social media content in response to an execution of a search, or detection of a combination of one or more enterprise-related search terms and one or more terms from the library of terms in the social media content in response to an execution of a search.

In some embodiments, the content module 110 can search content on multiple social network applications, such as Facebook (public pages), Flickr, Google+, Instagram, Meetup, Tumblr, Twitter, Vimeo, YouTube, WordPress, 4chan, Whisper, forums, and others. The content module 110 may assess publicly available content on social network applications including posts, photos, videos, comments, location information, user profile information, and other content. The content module 110 can execute step 506 of searching and identifying the social media content that includes safety and wellness climate concerns continuously or after a specified time interval.

In some embodiments, the library of terms can be or include a safety and wellness library of terms. The safety and wellness library of terms can include a subgroup of terms that are related with safety concerns.

In some embodiments, one or more attributes of the social media content can establish a relationship between the social media content and the enterprise. The one or more attributes can include, but are not limited to one or more of: a geo-location associated with the social media content, information regarding an author of the social media content, metadata of the social media content.

In some embodiments, the searches for one or more terms from the library of terms in social media content can be automatically executed at periodic time intervals.

In some embodiments that employ enterprise-related search terms, the enterprise-related search terms can be provided by the enterprise at an earlier time or can be based on information provided by the enterprise at an earlier time. The enterprise-related search terms can include keywords, phrases or hashtags. The enterprise-related search terms can include terms that identify or describe assets or enterprises of interest. Searching based on a combination of one or more enterprise-related search terms and one or more library terms provides results that are enterprise-relevant so that a later step of determining the existence of a relationship between the social media content or the social media content author and the enterprise is not needed for those search results.

In some embodiments employing enterprise-related search terms, the enterprise-related search terms may be stored in the database to run periodic searches of social media content to identify and safety and wellness climate concerns. In some embodiments, an enterprise may provide words and/or phrases that describe an asset or enterprise of interest to the enterprise, or enterprise user may provide a list of persons associated with the enterprise. For example, in some embodiments, a web form may be used to receive information regarding an enterprise and/or persons or organizations associated with the enterprise. A database of search terms may be generated based on these words and/or phrases and list of persons associated with the enterprise. The database of search terms may be generated by natural language processing of the words, phrases, and list of persons provided by the user. The database of search terms may be stored as search terms for a particular user or enterprise.

In step 508, where identifying social media content including safety and wellness climate concerns is based on detection of one or more terms from the library of terms in the social media content in response to an execution of a search, the content module 110 identifies enterprise-relevant social media content that includes safety and wellness climate concerns by determining an existence of a relationship between the enterprise and the identified social media content that includes safety and wellness climate concerns.

In step 510, where identifying social media content that includes safety and wellness climate concerns is based on detection of one or more terms from the library of terms and one or more attributes in the social media content in response to an execution of a search, or detection of a combination of one or more enterprise-related search terms and one or more terms from the library of terms in the social media content in response to an execution of a search., the content module 110 identifies the resulting social media content as enterprise-relevant social media content that includes safety and wellness climate concerns.

In step 512, the analysis module 150 can aggregate and analyze information regarding the identified enterprise-relevant social media content that includes safety and wellness climate concerns. The analysis module 150 stores information regarding each item of social media content identified as being relevant to the safety and wellness climate of an enterprise. In some embodiments, the stored information includes some or all of the following: topic(s) under which the item was identified, a subtopic under which the item was identified, and the library term or terms used in the search that identified the item. In some embodiments, the stored information may include other important keywords appearing in the item. The embodiments provide that any personally identifying information regarding the author of the social media content will not be stored, or will be redacted or deleted from the stored information before the information is displayed on a graphical user interface. In some embodiments, what information is stored is determined in part, by an agreement with the social media provider of the content. In embodiments, the system can save or store selected information associated with the content from the individual items (i.e., posts), but not the post itself. The system protects the privacy of the author by removing/not storing/redacting/deleting any identifying information associated with the author that may be determined based on detection of the identifying information, or based on an agreement with the social media providers.

FIG. 6 is a flowchart showing an example method 600 for identifying security, safety, and wellness climate concerns from social media content. In step 602, a library of terms in can be stored in a database. The library of terms can include terms to constrain searching of social media content to threatening content. In step 604 a safety and wellness content library of terms can store in a database. The library of terms include terms to constrain searching of social media content to safety and wellness climate concerns. In operation 606, the system 100 can obtain or access an identification of an enterprise.

In step 608, the content module 110 can search and identify social media content that includes threating content or safety and wellness climate concerns based on one or more of the following: detection of one or more of terms from the threatening content library of terms in the social media content or detection of one or more terms from the safety and wellness library of terms associated with safety concerns, in response to an execution of a search, detection of one or more terms from the threatening content library of terms or the safety and wellness library of terms and one or more attributes in the social media content in response to an execution of a search, or detection of a combination of one or more enterprise-related search terms and one or more terms from the threatening content library of terms or the safety and wellness library of terms in the social media content in response to an execution of a search.

In some embodiments the content module 110 searches and identifies social media content that includes threating content or safety and wellness climate concerns based on two or more of the following: detection of one or more of terms from the threatening content library of terms in the social media content or detection of one or more terms from the safety and wellness library of terms associated with safety concerns, in response to an execution of a search, detection of one or more terms from the threatening content library of terms or the safety and wellness library of terms and one or more attributes in the social media content in response to an execution of a search, or detection of a combination of one or more enterprise-related search terms and one or more terms from the threatening content library of terms or the safety and wellness library of terms in the social media content in response to an execution of a search.

In some embodiments the content module 110 searches and identifies social media content that includes threating content or safety and wellness climate concerns based on all three of the following: detection of one or more of terms from the threatening content library of terms in the social media content or detection of one or more terms from the safety and wellness library of terms associated with safety concerns, in response to an execution of a search, detection of one or more terms from the threatening content library of terms or the safety and wellness library of terms_and one or more attributes in the social media content in response to an execution of a search, or detection of a combination of one or more enterprise-related search terms and one or more terms from the threatening content library of terms or the safety and wellness library of terms in the social media content in response to an execution of a search.

In some embodiments, the threatening content library of terms and the safety and wellness library of terms may have one or more of the same terms. In some embodiments, the safety and wellness library of terms may include a subgroup of terms associated with safety concerns.

In some embodiments, the content module 110 can search content on multiple social network applications, such as Facebook (public pages), Flickr, Google+, Instagram, Meetup, Tumblr, Twitter, Vimeo, YouTube, WordPress, 4chan, Whisper, forums, and others. The content module 110 may assess publicly available content on social network applications including posts, photos, videos, comments, location information, user profile information, and other content. The content module 110 can execute step 506 of searching and identifying the social media content that includes safety and wellness climate concerns continuously or after a specified time interval.

In some embodiments, attributes of the social media content can establish a relationship between the social media content and the enterprise. In some embodiments, the one or more attributes include, but are not limited to, one or more of: a geo-location associated with the social media content, information regarding an author of the social media content, metadata of the social media content.

In some embodiments, the searches for one or more terms from the library of terms in social media content can be automatically executed at periodic time intervals.

In some embodiments employing enterprise-related search terms, one or more of the enterprise-related search terms can be provided by the enterprise at an earlier time. The enterprise-related search terms can include be keywords, phrases or hashtags. The enterprise-related search terms can include term that identify or describe assets or enterprises of interest. Searching based on a combination of one or more enterprise-related search terms and one or more library terms provides results that are enterprise-relevant so that a later step of determining the existence of a relationship between the social media content or the social media content author and the enterprise is not needed for those search results.

In some embodiments, the enterprise-related search terms, terms may be stored in the database to run periodic searches of social media content to identify and safety and wellness climate concerns or threating content. In some embodiments, an enterprise may provide words and/or phrases that describe an asset or enterprise of interest to the enterprise, or enterprise user may provide a list of persons closely related with the enterprise. For example, in some embodiments, a web form may be used to receive information regarding an enterprise and/or persons or organizations associated with the enterprise. A database of search terms may be generated based on these words and/or phrases and list of persons associated with the enterprise. The database of search terms may be generated by natural language processing of the words, phrases, and list of persons provided by the user. The database of search terms may be stored as search terms for a particular user or enterprise.

In step 610 where identifying social media content that includes threatening content or safety and wellness climate concerns is based on detection of one or more of terms from the threatening content library of terms in the social media content or detection of one or more terms from the safety and wellness library of terms associated with safety concerns, in response to an execution of a search, the content module 110 identifies enterprise-relevant social media content that includes the threatening content or safety and wellness climate concerns by determining an existence of a relationship between the enterprise and the identified social media content that includes threatening content or safety and wellness climate concerns.

In step 612, where identifying social media content that includes threatening content or safety and wellness climate concerns is based on detection of one or more terms from the threatening content library of terms or the safety and wellness library of terms and one or more attributes in the social media content in response to an execution of a search, or detection of a combination of one or more enterprise-related search terms and one or more terms from the threatening content library of terms or the safety and wellness library of terms in the social media content in response to an execution of a search, the content module 110 identifies the resulting social media content as enterprise-relevant social media content that includes threatening content or safety and wellness climate concerns.

In step 614, where the identified enterprise-related social media content that includes threatening content or safety and wellness climate concerns includes safety and wellness climate concerns the analysis module 150 can aggregate and analyze information regarding the identified enterprise-relevant social media content that includes safety and wellness climate concerns. In some embodiments, the analysis module 150 stores information regarding each item of social media content identified as being relevant to the safety and wellness climate of an enterprise. In some embodiments, the stored information includes some or all of the following: topic(s) under which the item was identified, a subtopic under which the item was identified, and the library term or terms used in the search that identified the item. In some embodiments, the stored information may include other important keywords appearing in the item. The embodiments provide that any personally identifying information regarding the author of the social media content will not be stored, or will be redacted or deleted from the stored information before the information is displayed on a graphical user interface. No personally identifying information regarding the social media content author is stored. In some embodiments, what information is stored is determined in part, by an agreement with the social media provider of the content. In embodiments, the system can save or store selected information associated with the content from the individual items (i.e., posts), but not the post itself. The system protects the privacy of the author by removing/not storing/redacting/deleting any identifying information associated with the author, which may be determined based on detection of the identifying information, or based on an agreement with the social media providers.

In step 616, where the identified enterprise-related social media content that includes threatening content or safety and wellness climate concerns includes threating content, the alert module 130 can transmit an alert to a device associated with the enterprise. The alert module 130 can generate and transmit a threat alert to the associated enterprise identifying content that includes safety and security threat concerns, which is also referred to as threatening content, so that the enterprise may address or mitigate the threat. The threat alert may be transmitted as an email message, a SMS message, or other communication means. In some embodiments, the alert may be incorporated into a report including multiple alerts for the enterprise.

FIG. 7 illustrates a network diagram depicting a system 700 for implementing embodiments of the system described herein. The system 700 can include a network 705, a device 710, a server 720, database(s) 730, and social media web domains 750. Each of the device 710, server 720, database(s) 730, and social media web domains 750 is in communication with the network 705.

In an example embodiment, one or more portions of network 705 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The device 710 may comprise, but is not limited to, work stations, computers, general purpose computers, Internet appliances, hand-held devices, wireless devices, portable devices, wearable computers, cellular or mobile phones, portable digital assistants (PDAs), smartphones, tablets, ultrabooks, netbooks, laptops, desktops, multi-processor systems, microprocessor-based or programmable consumer electronics, network PCs, mini-computers, and the like. The device 710 may include one or more components described in relation to FIG. 5.

The device 710 may connect to network 705 via a wired or wireless connection. The device 710 may include one or more applications or systems such as, but not limited to, a social media application, the system described herein (for example, system 100), and the like. In an example embodiment, the device 710 may perform all the functionalities described herein. The device 710 can further include a display 755 configured to render a GUI 760.

In other embodiments, the system 100 may be included on device 710, and the server 720 performs the functionalities described herein. In yet another embodiment, the device 710 may perform some of the functionalities of the system 100, and server 720 performs the other functionalities described herein. For example, device 710 may receive the search term from a user, while server 720 may combine the search with one or more terms from the library and search social media content to identify content that includes safety and security concerns.

The database(s) 730 may store the library terms 735 (i.e., threatening content library of terms database 140a and a safety and wellness library of terms database 140b) and asset information or search terms provided by the user. The database(s) 730 may also store information regarding the search results for later analysis. Each of the server 720 and database(s) 730 is connected to the network 705 via a wired connection. Alternatively, one or more of the server 720 and database(s) 730 may be connected to the network 705 via a wireless connection. Server 720 comprises one or more computers or processors configured to communicate with device 710 and/or database(s) 730 via network 705. Server 720 hosts one or more applications or websites accessed by device 710 and/or facilitates access to the content of database(s) 730. Server 720 also may include the system 100 described herein. Database(s) 730 comprise one or more storage devices for storing data and/or instructions (or code) for use by server 720 and/or device 710. Database(s) 730 and server 720 may be located at one or more geographically distributed locations from each other or from device 710. Alternatively, database(s) 730 may be included within server 720.

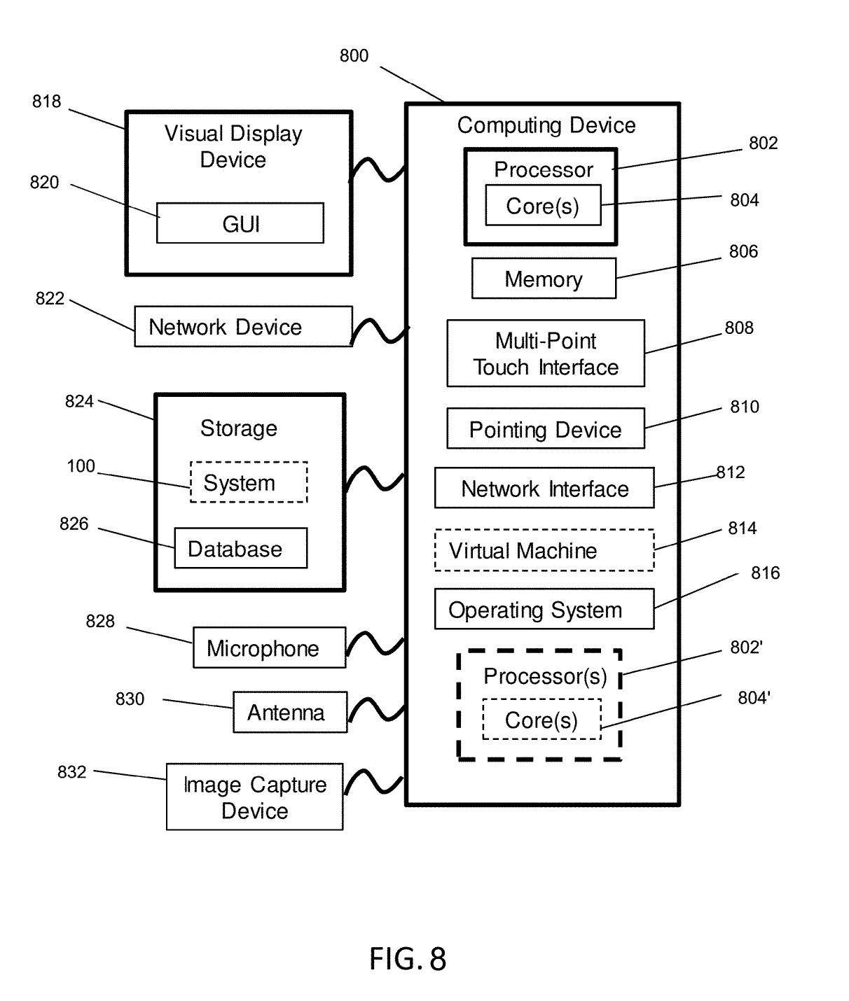

FIG. 8 is a block diagram of an exemplary computing device 800 that may be used to implement exemplary embodiments of the system described herein. The computing device 800 includes one or more non-transitory computer-readable media for storing one or more computer-executable instructions or software for implementing exemplary embodiments. The computing device 800 can be part of or can be embodied as the device (e.g., device 710 as shown in FIG. 7). The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 806 included in the computing device 800 may store computer-readable and computer-executable instructions or software for implementing exemplary embodiments of the system 100. The computing device 800 also includes configurable and/or programmable processor 802 and associated core(s) 804, and optionally, one or more additional configurable and/or programmable processor(s) 802′ and associated core(s) 804′ (for example, in the case of computer systems having multiple processors/cores), for executing computer-readable and computer-executable instructions or software stored in the memory 806 and other programs for controlling system hardware. Processor 802 and processor(s) 802′ may each be a single core processor or multiple core (804 and 804′) processor.

Virtualization may be employed in the computing device 800 so that infrastructure and resources in the computing device may be shared dynamically. A virtual machine 814 may be provided to handle a process running on multiple processors so that the process appears to be using only one computing resource rather than multiple computing resources. Multiple virtual machines may also be used with one processor.

Memory 806 may include a computer system memory or random access memory, such as DRAM, SRAM, EDO RAM, and the like. Memory 806 may include other types of memory as well, or combinations thereof.

An enterprise user may interact with the computing device 800 through a visual display device 818, such as a computer monitor, which may display one or more graphical user interfaces 822 that may be provided in accordance with exemplary embodiments. The computing device 800 may include other I/O devices for receiving input from a user, for example, a keyboard or any suitable multi-point touch interface 808, a pointing device 810 (e.g., a mouse), a microphone 828, and/or an image capturing device 832 (e.g., a camera or scanner). The multi-point touch interface 808 (e.g., keyboard, pin pad, scanner, touch-screen, etc.) and the pointing device 810 (e.g., mouse, stylus pen, etc.) may be coupled to the visual display device 818. The computing device 800 may include other suitable conventional I/O peripherals.

The computing device 800 may also include one or more storage devices 824, such as a hard-drive, CD-ROM, or other computer readable media, for storing data and computer-readable instructions and/or software that implement exemplary embodiments of the system described herein. Exemplary storage device 824 may also store one or more databases for storing any suitable information required to implement exemplary embodiments. For example, exemplary storage device 824 can store one or more databases 826 for storing information, such terms of the library of the system, and any other information to be used by embodiments of the system 100. The databases may be updated manually or automatically at any suitable time to add, delete, and/or update one or more data items in the databases.

The computing device 800 can include a network interface 812 configured to interface via one or more network devices 820 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. In exemplary embodiments, the computing device 800 can include one or more antennas 830 to facilitate wireless communication (e.g., via the network interface) between the computing device 800 and a network. The network interface 812 may include a built-in network adapter, network interface card, PCMCIA network card, card bus network adapter, wireless network adapter, USB network adapter, modem or any other device suitable for interfacing the computing device 800 to any type of network capable of communication and performing the operations described herein. Moreover, the computing device 800 may be any computer system, such as a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein.

The computing device 800 may run any operating system 816, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 816 may be run in native mode or emulated mode. In an exemplary embodiment, the operating system 816 may be run on one or more cloud machine instances.

In describing exemplary embodiments, specific terminology is used for the sake of clarity.

For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. A method for identifying safety and wellness climate concerns from social media content, the method comprising:
storing a library of terms in a database, the library of terms including terms to constrain searching of social media content to safety and wellness climate concerns;
obtaining or accessing an identification of an enterprise;
identifying social media content that includes safety and wellness climate concerns based on one or more of the following:
A) detection of one or more terms from the library of terms associated with safety concerns in the social media content in response to an execution of a search,
B) detection of one or more terms from the library of terms and one or more attributes in the social media content in response to an execution of a search, or
C) detection of a combination of one or more enterprise-related search terms and one or more terms from the library of terms in the social media content in response to an execution of a search,
where identifying social media content that includes safety and wellness climate concerns is based on A), identifying enterprise-relevant social media content that includes safety and wellness climate concerns by determining an existence of a relationship between the enterprise and the identified social media content that includes safety and wellness climate concerns,
where identifying social media content that includes safety and wellness climate concerns is based on B) or C), the identified social media content is enterprise-relevant social media content that includes safety and wellness climate concerns; and
aggregating and analyzing information regarding the identified enterprise-relevant social media content that includes safety and wellness climate concerns.

2. The method of claim 1, wherein the one or more attributes establish a relationship between the social media content and the enterprise.

3. The method of claim 1, wherein the one or more attributes include one or more of: a geo-location associated with the social media content, information regarding an author of the social media content, or metadata of the social media content.

4. The method of claim 1, wherein information identifying an author of the social media content is removed or redacted from the information regarding the identified enterprise-relevant social media content that includes safety and wellness climate concerns prior to aggregation and analysis of the information regarding the identified enterprise-relevant social media content that includes safety and wellness climate concerns.

5. The method of claim 4, further comprising displaying results of the aggregation and analysis of information regarding the identified enterprise-relevant social media content that includes safety and wellness climate concerns via a graphical user interface, wherein information identifying the author of the social media content is removed or redacted from the information regarding the identified enterprise-relevant social media content that includes safety and wellness climate concerns prior to displaying results of the aggregation and analysis via a graphical user interface.

6. The method of claim 1, further comprising automatically executing by the processor, searches for one or more terms from the library of terms in social media content at periodic time intervals.

7. The method of claim 1, wherein the one or more enterprise-related search terms include one or more search terms provided by the enterprise.

8. The method of claim 1, wherein the one or more search terms are stored in a database.

9. The method of claim 1, wherein terms in the library are organized into topics and each topic includes an algorithm used to combine the one or more enterprise-related search terms with the one or more terms from the library under the respective topic, wherein an algorithm for one or more of the topics is different for an algorithm for another of the topics.

10. The method of claim 1, wherein the existence of the relationship between the social media content that includes safety and wellness climate concerns and the enterprise is determined by the social media content or the one or more attributes.

11. The method of claim 1, wherein the one or more search terms relate to or describe the enterprise.

12. The method of claim 1, wherein information regarding the identified enterprise-relevant social media content that includes safety and wellness climate concerns is analyzed to detect a trend and a trend alert is issued based on the analysis.

13. The method of claim 12, further comprising generating and transmitting the trend alert to the enterprise.

14. A method for identifying security, safety, and wellness climate concerns from social media content, the method comprising:
storing a threating content library of terms in a database, the library of terms including terms to constrain searching of social media content to threating content;
storing a safety and wellness content library of terms in a database, the library of terms including terms to constrain searching of social media content to safety and wellness climate concerns;
obtaining or accessing an identification of an enterprise;
identifying social media content that includes threating content or safety and wellness climate concerns based on one or more of the following:
A) detection of one or more of terms from the threatening content library of terms in the social media content or detection of one or more terms from the safety and wellness library of terms associated with safety concerns, in response to an execution of a search,
B) detection of one or more terms from the threatening content library of terms or the safety and wellness library of terms_and one or more attributes in the social media content in response to an execution of a search, or
C) detection of a combination of one or more enterprise-related search terms and one or more terms from the threatening content library of terms or the safety and wellness library of terms in the social media content in response to an execution of a search,
where identifying social media content that includes threatening content or safety and wellness climate concerns is based on A), identifying enterprise-relevant social media content that includes the threatening content or safety and wellness climate concerns by determining an existence of a relationship between the enterprise and the identified social media content that includes threatening content or safety and wellness climate concerns;
where identifying social media content that includes threatening content or safety and wellness climate concerns is based on B) or C), the identified social media content is enterprise-relevant social media content that includes threatening content or safety and wellness climate concerns;
where the identified enterprise-related social media content that includes threatening content or safety and wellness climate concerns includes safety and wellness climate concerns, aggregating and analyzing information regarding the social media content in the enterprise-relevant social media content that includes safety and wellness climate concerns; and
wherein the identified enterprise-related social media content that includes threatening content or safety and wellness climate concerns includes threating content, transmitting an alert to a device associated with the enterprise.

15. The method of claim 14, wherein the one or more attributes establish a relationship between the social media content and the enterprise.

16. The method of claim 15, wherein the one or more attributes includes one or more of: a geo-location associated with the social media content, information regarding an author of the social media content, metadata of the social media content.

17. The method of claim 14, wherein information identifying an author of the social media content is removed or redacted from the information regarding the identified enterprise-relevant social media content that includes safety and wellness climate concerns prior to aggregation and analysis of the information regarding the identified enterprise-relevant social media content that includes safety and wellness climate concerns.

18. The method of claim 14, further comprising displaying results of the aggregation and analysis of information regarding the identified enterprise-relevant social media content that includes safety and wellness climate concerns via a graphical user interface, wherein information identifying the author of the social media content is removed or redacted from the information regarding the identified enterprise-relevant social media content that includes safety and wellness climate concerns prior to displaying results of the aggregation and analysis via a graphical user interface.

19. The method of claim 14, further comprising automatically executing by the processor, searches for one or more terms from the library of terms in social media content at periodic time intervals.

20. The method of claim 14, wherein the one or more enterprise-related search terms include one or more search terms provided by the enterprise.

21. The method of claim 14, wherein the one or more enterprise-related search terms are stored in a database.

22. The method of claim 14, wherein terms in the threatening content or safety and wellness library are organized into topics.

23. A system for identifying safety and wellness climate concerns from social media content, the system comprising:
a processor;
and a memory in communication with the processor, the memory can store instructions that causes the processor to:
store a library of terms in a database, the library of terms including terms to constrain searching of social media content to safety and wellness climate concerns;
obtain or access an identification of an enterprise;
identify social media content that includes safety and wellness climate concerns based on one or more of the following:
A) detection of one or more terms from the library of terms in the social media content associated with safety concerns in response to an execution of a search,
B) detection of one or more terms from the library of terms and one or more attributes in the social media content in response to an execution of a search, or
C) detection of a combination of one or more enterprise-related search terms and one or more terms from the library of terms in the social media content in response to an execution of a search,
where the identification of social media content that includes safety and wellness climate concerns is based on A), enterprise-relevant social media content that includes safety and wellness climate concerns is identified by determining an existence of a relationship between the enterprise and the identified social media content that includes safety and wellness climate concerns,
where the identification of social media content that includes safety and wellness climate concerns is based on B) or C), the identified social media content is enterprise-relevant social media content that includes safety and wellness climate concerns; and
aggregate and analyze information regarding the identified enterprise-relevant social media content that includes safety and wellness climate concerns.

24. A non-transitory computer-readable storage medium storing code representing instructions that when executed are configured to cause a processor to:
store a library of terms in a database, the library of terms including terms to constrain searching of social media content to safety and wellness climate concerns;
obtain or accessing an identification of an enterprise;
identify social media content that includes safety and wellness climate concerns based on one or more of the following:
A) detection of one or more terms from the library of terms in the social media content associated with safety concerns in response to an execution of a search,
B) detection of one or more terms from the library of terms and one or more attributes in the social media content in response to an execution of a search, or
C) detection of a combination of one or more enterprise-related search terms and one or more terms from the library of terms in the social media content in response to an execution of a search,
where identifying social media content that includes safety and wellness climate concerns is based on A), identify enterprise-relevant social media content that includes safety and wellness climate concerns by determining an existence of a relationship between the enterprise and the identified social media content that includes safety and wellness climate concerns,
where identifying social media content that includes safety and wellness climate concerns is based on B) and C), the identified social media content is enterprise-relevant social media content that includes safety and wellness climate concerns; and
aggregate and analyze information regarding the identified enterprise-relevant social media content that includes safety and wellness climate concerns.
